(19) United States
(12) Patent Application Publication
(10) Pub. No.: US 2019/0172635 A1
(43) Pub. Date: Jun. 6, 2019

(54) Phase Shift Unit

(71) Applicant: Qualcomm Incorporated, San Diego, CA (US)

(72) Inventors: Bon-Hyun Ku, San Diego, CA (US); Hyunchul Park, San Diego, CA (US)

(21) Appl. No.: 16/210,976

(22) Filed: Dec. 5, 2018

Related U.S. Application Data
(60) Provisional application No. 62/595,042, filed on Dec. 5, 2017.

(51) Int. Cl. H01F 27/38; H01F 30/12; H01Q 3/36

(52) U.S. Cl. CPC H01F 27/38; H01Q 3/36; H01F 30/12

(57) ABSTRACT

Methods and apparatuses can implement a phase shifter including at least one phase shift unit. In an example aspect, the phase shift unit has an inductive-capacitive (LC) core that includes an inductor to provide an inductance and a transistor to provide a capacitance using a parasitic capacitance thereof. In some implementations, the LC core includes a first connector node, a second connector node, a transistor, a first inductor, and a second inductor. The transistor is coupled between the first and second connector nodes and is configured to provide a capacitance to the LC core. The first inductor is coupled to the first connector node and is configured to provide a first inductance. The second inductor is coupled to the second connector node and is configured to provide a second inductance. Using a pi-type circuit topology for the LC core can reduce an insertion loss of the phase shift unit.

### CROSS-REFERENCE TO RELATED APPLICATION(S)

This Application claims the benefit of U.S. Provisional Application No. 62/595,042, filed 5 Dec. 2017, the disclosure of which is hereby incorporated by reference in its entirety herein.

### TECHNICAL FIELD

This disclosure relates generally to electronic communications and, more specifically, to shifting a phase of a signal with one or more phase shift units.

### BACKGROUND

Electronic devices include traditional computing devices such as desktop computers, notebook computers, smartphones, wearable devices like a smartwatch, internet servers, and the like. However, electronic devices also include other types of computing devices such as personal voice assistants, thermostats, automotive electronics, robotics, devices embedded in other machines like refrigerators and industrial tools, Internet-of-Things (IoTs) devices, and so forth. These various electronic devices provide information, entertainment, social interaction, security, safety, productivity, transportation, and other services to human users. Thus, electronic devices play crucial roles in many aspects of modern society.

Many of the services provided by electronic devices in today's interconnected world depend at least partly on electronic communications. Electronic communications can include those exchanged between or among distributed electronic devices using wireless or wired signals that are transmitted over one or more networks, such as the Internet or a cellular network. With cellular technology, for example, electronic communications are usually accomplished by propagating signals between two points, such as between a mobile phone and a base station. Typically, such electronic communications are performed using a signal that is designed to have a specified frequency. These specified frequencies have expanded over the years with different wireless network standards, including those for both Wi-Fi and cellular networks.

Current wireless standards, such as Fourth Generation (4G) or Long-Term Evolution (LTE) cellular standards, use frequencies up to the single-digit GHz, such as 2-5 GHz. These frequencies support applications like video calling, watching high-definition (HD) video, and interacting with social media platforms. Future applications for wireless networks, however, will offer virtual reality (VR), including 3D imaging; an ability to watch ultra-HD (UHD) video; nearly-instantaneous communication among autonomous, self-driving vehicles; and other features that are still being developed or have yet to be conceived. These future applications will demand even greater bandwidth and lower latency than is provided by 4G networks or older Wi-Fi standards.

To accommodate greater data bandwidths and lower latencies, future Fifth-Generation (5G) cellular networks and newer Wi-Fi networks (e.g., those based on IEEE 802.11ad/ay/ax) are expected to use even higher frequencies, such as those in the 10s of GHz (e.g., 28 GHz, 60 GHz, and 95 GHz). Such high-frequency signals are also called millimeter wave (mmW) signals due to the sizes of the electromagnetic waves corresponding to these frequencies. These higher frequencies can provide data more quickly and with less delay. However, working with such higher frequencies also introduces new challenges that have not yet been met. Consequently, electrical engineers and other researchers are striving to discover how to enable electronic devices to transmit and receive mmW signals, and other higher frequency signals, effectively, efficiently, and at a reasonable cost.

### SUMMARY

Example implementations for a phase shift unit are disclosed herein. In an example aspect, a phase shifter includes multiple phase shift units coupled together in a chained arrangement. Each individual phase shift unit is configured to shift a phase of a transiting signal by a particular phase shift amount responsive to a respective shift-unit control signal. In some implementations, each particular phase shift amount is different, such as 45°, 90°, and 180°. At least one of the phase shift units has a respective inductive-capacitive core (LC core) that includes an inductor to provide an inductance. Further, to avoid using a traditional process-sensitive capacitor, the LC core can also include a transistor to provide a capacitance using a parasitic capacitance thereof. In operation, the respective shift-unit control signal can turn the transistor on or off In some configurations, if the transistor is turned on, the transistor functions like a resistor based on an on-resistance of the transistor. On the other hand, if the transistor is turned off, the transistor functions like a capacitor based on an off-capacitance, which arises from the parasitic capacitance of the transistor. The LC core can include two inductors and a transistor. These three components can be arranged in a T-type circuit topology. However, a T-type circuit presents an appreciable insertion loss that attenuates a strength of a transiting signal. Accordingly, these three circuit components can alternatively be arranged in a pi-type circuit topology to reduce the insertion loss.

In an example aspect, an apparatus is disclosed. The apparatus includes a phase shift unit having an inductive-capacitive core (LC core). The LC core includes a first connector node, a second connector node, a transistor, a first inductor, and a second inductor. The transistor has a first terminal coupled to the first connector node and a second terminal coupled to the second connector node. The transistor is configured to selectively provide a capacitance to the LC core. The first inductor is coupled to the first connector node, and the first inductor is configured to provide a first inductance to the LC core. The second inductor is coupled to the second connector node, and the second inductor is configured to provide a second inductance to the LC core.

In an example aspect, a system is disclosed that includes a phase shifter. The phase shifter includes a first phase shift unit, a second phase shift unit, and a third phase shift unit. The first phase shift unit corresponds to a first phase shift amount. The first phase shift unit includes means for shifting a phase of a signal with a pi-type circuit topology using a transistor that is configured to selectively contribute a parasitic capacitance to an inductive-capacitive core (LC core) of the first phase shift unit. The second phase shift unit is coupled to the first phase shift unit, and the second phase shift unit corresponds to a second phase shift amount. The third phase shift unit is coupled to the first phase shift unit, and the third phase shift unit corresponds to a third phase shift amount.

In an example aspect, a method for operating at least one phase shift unit is disclosed. The method includes, responsive to a deactivation signal being applied to a phase shift unit, turning a transistor on and propagating a signal through the transistor in an ON state to transit the signal through the phase shift unit. The method also includes, responsive to an activation signal being applied to the phase shift unit, turning the transistor off and transiting the signal through the phase shift unit, including shifting a phase of the signal using an inductive-capacitive core (LC core). The signal is transited through the phase shift unit with the transistor in an OFF state to contribute a parasitic capacitance to the LC core of the phase shift unit.

In an example aspect, a phase shift unit is disclosed. The phase shift unit includes a transistor, a first inductor, and a second inductor. The transistor has a first terminal connected to an input of the phase shift unit and a second terminal connected to an output of the phase shift unit. The first inductor has a first terminal connected to the first terminal of the transistor and has a second terminal directly connected to a ground network. The second inductor has a first terminal connected to the second terminal of the transistor and has a second terminal directly connected to the ground network.

### BRIEF DESCRIPTION OF DRAWINGS

FIG. 1 illustrates an example environment that includes a communication unit in which a phase shifter with at least one phase shift unit can be implemented.

FIG. 2 illustrates an example communication unit that includes a phase shifter implemented as part of a transmit or receive chain.

FIG. 3 illustrates an example phase shifter including multiple phase shift units that are controlled by a phase shifter controller.

FIG. 4-1 illustrates an example implementation of a phase shifter having three phase shift units, some of which may include an inductive-capacitive (LC) core.

FIG. 4-2 illustrates, for the phase shifter of FIG. 4-1, multiple phase shift units, each of which may include a different example type of circuit topology for an LC core thereof.

FIG. 5 illustrates a phase shift unit including an example LC core having an inductor to provide inductance and a transistor to provide capacitance via a parasitic capacitance thereof.

FIG. 6-1 illustrates example circuitry for a phase shifter having three phase shift units, each of which corresponds to a different phase shift amount.

FIG. 6-2 illustrates, for the phase shifter of FIG. 6-1, overlays of example types of circuit topology for two of the three phase shift units.

FIG. 7 illustrates an example of circuitry for a phase shift unit having an example pi-type circuit, which may be implemented for a 90° phase shift amount.

FIG. 8 illustrates an example portion of the phase shift unit of FIG. 7 with regard to two operational modes that can be utilized with the pi-type circuit.

FIG. 9 illustrates alternative example circuitry for a phase shifter having three phase shift units, each of which corresponds to a different phase shift amount.

FIG. 10 is a flow diagram illustrating an example process for operating a phase shifter with multiple phase-shift units.

FIG. 11 is a flow diagram illustrating an example process for operating a phase shift unit having a pi-type circuit.

FIG. 12 illustrates an example electronic device in which a phase shift unit can be implemented.

### DETAILED DESCRIPTION

Next generation networks, such as a wireless wide area network (WWAN) or a wireless local area network (WLAN), are expected to operate at frequencies that will reach the 10s of GHz. For example, 5G cellular and other WWAN networks may operate with frequencies starting at under 10 GHz but reaching over 90 GHz. More specifically, systems that implement 5G may transmit at frequencies in, for instance, a 28 GHz band. Also, the IEEE 802.11ad Wi-Fi protocol, which is an example protocol that can be employed to build a WLAN, is targeting frequencies that include 60 GHz. These mmW signals (e.g., signals with frequencies between approximately 10 GHz and 300 GHz) present some problems, such as they typically fail to penetrate walls. Further, mmW signals attenuate relatively quickly in the atmosphere, especially with humid weather. To counteract these problems, next generation wireless networks can adopt antenna beamforming With antenna beamforming, from a transmission perspective, a radio frequency (RF) signal can be emanated from an antenna array having multiple antenna elements. The RF signal is effectively emanated as multiple RF signal portions or versions that combine constructively at some geospatial positions and combine destructively at other geospatial positions. Thus, the resulting RF signal has different strengths at different locations such that one or more signal beams are said to be generated (e.g., produced, incident, or receptively aimed) at the locations having the higher signal strengths.

A signal beam can be shaped using an antenna array to have a particular length, width, pattern, distance, cross-sectional area in the atmosphere or spread across the ground, and so forth. Further, the antenna array can aim the signal beam in a desired direction, even without physically moving the antenna array. Aiming a signal beam can enable an RF signal to target an intended destination or to be reflected from one or more objects to reach the intended destination. Additionally, using a signal beam, a given power level that is applied to emanating an RF signal can result in the signal propagating further than without antenna beamforming, even with the relatively higher frequencies of mmW signals. Furthermore, antenna signal beams can be employed bi-directionally. In other words, a relatively weaker RF signal can be correctly received by aiming a signal beam toward a direction of an incoming RF signal. Thus, antenna beamforming can facilitate the use of higher frequencies and therefore enable future applications that demand higher bandwidths and lower latencies than can be provided by today's current 4G WWAN systems and existing IEEE 802.11 WLAN systems.

Generally, an electronic device generates a signal beam using a beamformer. The beamformer determines beamformer parameters (sometimes called beamforming weights) for each antenna element of an antenna array to create a desired beam pattern (e.g., an emanation pattern or a reception pattern). Two example types of beamformer parameters, which are usable to generate signal beams, are amplitude and phase shift. Example apparatuses and methods are described herein for generating phase shifts for different signal portions corresponding to different antenna elements. These phase shifts can be used to steer a signal beam.

To generate phase shifts, various components can be used. Examples of such components include an active vector modulator and a passive phase shifter. The active vector modulator is relatively easy to calibrate, but it consumes power. Vector modulators are also unidirectional, which means having one for transmission circuitry and another for reception circuitry. The passive phase shifter, on the other hand, does not consume an appreciable amount of power and also offers bidirectional operation (e.g., a single passive phase shifter circuit can be employed for both transmit and receive parts of a communication).

One type of passive phase shifter is the switched inductor-capacitor phase shifter, which includes at least one inductor-capacitor core to delay a signal. Although a simple version of a switched inductor-capacitor phase shifter may be straightforward to implement, such a passive phase shifter presents a number of issues. One issue is process sensitivity: The capacitor of the inductor-capacitor core causes large process variations, at least relative to the inductor or a transistor. Consequently, a typical switched inductor-capacitor phase shifter has a large phase variability over process variations. Further, calibration to account for this process-based phase variation is not easy to accomplish.

A second issue is insertion loss: A switched inductor-capacitor phase shifter for mmW signals has a large insertion loss because of the on-resistance of an in-line switch (e.g., a transistor) and the parasitic substrate capacitance from the transistor at GHz frequencies. Unfortunately, the size of the switch cannot be independently and freely increased to reduce the on-resistance because the size is directly related to the off-capacitance of the transistor, and this off-capacitance is interrelated with design parameters (e.g., a desired phase shift amount) of the inductor-capacitor core of the phase shifter. A third issue is size, or circuit area occupied by the components of the inductor-capacitor core. Both active and passive phase shifters typically include a large passive circuit, like coupled-lines or like an inductor or a transmission line. This large passive circuit usually occupies much of the total area consumed by the phase shifter.

Thus, a phase shifter providing lower insertion loss, less process sensitivity, or a smaller circuit area can facilitate the utilization of beamforming and therefor expedite the adoption of mmW signaling for next-generation wireless networks. Accordingly, implementations that are described herein enable a phase shifter that is less process-sensitive while offering a lower insertion loss. Further, described implementations occupy a smaller area and are suitable for use with an RF front-end that communicates using mmW signals.

In example implementations, a phase shifter is disposed along a transmit or receive chain to shift a phase of a communication signal to produce a phase-shifted communication signal. For instance, the phase shifter may be coupled between a power manipulator (e.g., a power combiner or a power splitter) and an amplifier, such as a power amplifier (PA) or a low-noise amplifier (LNA). The phase shifter includes multiple phase shift units. A phase shifter controller selectively activates zero or more of the phase shift units at any given time. Each phase shift unit can shift an incoming signal by some different predetermined phase shift amount, such as 45°, 90°, or 180°. By selectively activating some combination of these three example phase shift amounts, a phase shifter with three phase shift units can shift the communication signal by an amount between 0° and 315° in 45° increments. However, other phase shift amounts can additionally or alternatively be implemented, such as 22.5°, 11.25°, 5°, 60°, 73°, 120°, or 164°.

At least one phase shift unit includes an inductive-capacitive core (LC core). The component values—e.g., an inductive/inductance value and a capacitive/capacitance value—in the LC core at least partially establish the predetermined phase shift amount. Conversely, the inductive value or the capacitive value can be determined based on a desired phase shift amount, and responsive to a matching impedance and an intended frequency of operation. At least one inductor establishes the inductive value. However, instead of using a conventional capacitor, at least one transistor establishes the capacitive value. More specifically, a parasitic capacitance of a transistor in an OFF state is used to create a capacitance having a capacitive value that can establish a desired phase shift amount.

In some implementations, a passive phase shifter uses a switched LC topology for each of the 45° and 90° cells, while exploiting a differential signal path to achieve the 180° phase shift without relying on inductive or capacitive components. In these implementations, conventional capacitors may be omitted from the phase shifter, and transistors that are sized to switch between a low-resistance ON state and a high- or low-capacitance OFF state are used in their stead for the switched LC topologies, as described herein. For example, the parasitic capacitance of one or more of the transistors may provide a capacitance value that is less process sensitive than that of a conventional capacitor (e.g., a metal-insulator-metal (MIM) or metal-oxide-metal (MOM) capacitor). In these manners, a phase shifter as described herein enables phase shifting with both lower insertion loss and less process sensitivity.

Thus, as described herein, at least one phase shift unit utilizes a parasitic capacitance of a transistor to create a capacitance for an LC core. However, different circuit topologies can be deployed in different phase shift units. Examples of different types of circuit topologies include a pi-type circuit topology (or π-type circuit topology) and a T-type circuit topology. Each of these two types can be designed for high-pass or low-pass scenarios. The resulting four example circuit types for a core LC-filter network include a low-pass pi-type, a high-pass pi-type, a low-pass T-type, and a high-pass T-type. By way of example, both a low-pass T-type (LCL) and a high-pass pi-type (LCL) are described herein.

In example implementations for some phase shift units, a core LC-filter network is realized with a low-pass T-type circuit. The low-pass T-type circuit can be formed using two inductors across the top bar of the T-shape and one capacitive component disposed along the vertical post of the T-shape. In this arrangement, relatively lower frequencies are passed along the top bar, but relatively higher frequencies are shunted down the vertical post. As a result, a total inductance value across the top bar impacts an insertion loss experienced by a signal transiting a corresponding phase shift unit. The inductance value to be implemented is based on a matching impedance (Zₒ) to be achieved, a frequency of operation (fₒ), and a desired phase shift amount (ϕ). As a size of the desired phase shift amount increases, the total inductance value likewise increases. Consider the following example total inductance values for a matching impedance (Zₒ) of 50 ohms and a frequency of operation (fₒ) of 29 GHz: 27 picohenries (pH), 55 pH, 114 pH, and 274 pH for phase shift amounts of 11.25°, 22.5°, 45°, and 90°, respectively. Additionally, the total capacitance values for a matching impedance (Zₒ) of 50 ohms and a frequency of operation (fₒ) of 29 GHz are as follows: 21 femtofarads (fF), 42 fF, 78 fF, and 110 fF for phase shift amounts of 11.25°, 22.5°, 45°, and 90°, respectively. The total inductance values can be feasibly implemented for up to, e.g., a 45° phase shift amount. However, the 274 picohenry value for the 90° phase shift amount creates an insertion loss that is too inefficient to be tenable for practical applications. Based on the low-pass T-type circuit topology, because the resulting insertion loss is too great for a 90° phase shift amount, a traditional MIM or MOM capacitor would be implemented in the LC core, with the consequential problems as described above.

However, the high-pass pi-type circuit involves a different set of inductive and capacitive values for the same matching impedance and frequency of operation. Typically, the high-pass pi-type circuit has appreciably larger inductive and capacitive values as compared to the low-pass T-type circuit. With a high-pass pi-type circuit, the total inductance values for a matching impedance (Zₒ) of 50 ohms and a frequency of operation (fₒ) of 29 GHz are as follows: 2786 pH, 1380 pH, 662 pH, and 274 pH for phase shift amounts of 11.25°, 22.5°, 45°, and 90°, respectively. Additionally, the total capacitance values for a matching impedance (Zₒ) of 50 ohms and a frequency of operation (fₒ) of 29 GHz are as follows: 563 fF, 287 fF, 155 fF, and 110 fF for phase shift amounts of 11.25°, 22.5°, 45°, and 90°, respectively. In contrast with the low-pass T-type circuit, the high-pass pi-type circuit has values that decrease as a size of the phase shift amount increases. The inductive and capacitive values for the two circuit topologies actually converge at the 90° phase shift amount. In other words, due to the trigonometric functions used to compute the inductive and capacitive values for the different circuit topologies, each of the circuit topologies uses the same inductive and capacitive values at 90°.

Consequently, at a surface level, it may appear that no circuit topology can remedy the insertion loss problem presented by the low-pass T-type circuit because each circuit topology has the same total inductive value. However, the inventors realized that the total inductive value for each respective circuit topology can have a different impact on the insertion loss of a signal transiting the associated phase shift unit. For example, the high-pass pi-type circuit includes a capacitive component along a top bar of the pi-shape and a respective inductor as part of each respective vertical leg of the pi-shape. As a result, relatively higher frequency signals are passed through the high-pass pi-type circuit, and relatively lower frequency signals are shunted “downward” (e.g., to or toward ground). More specifically, a signal that transits an LC core having the high-pass pi-type circuit topology does not need to traverse both inductances, so the insertion loss is lower.

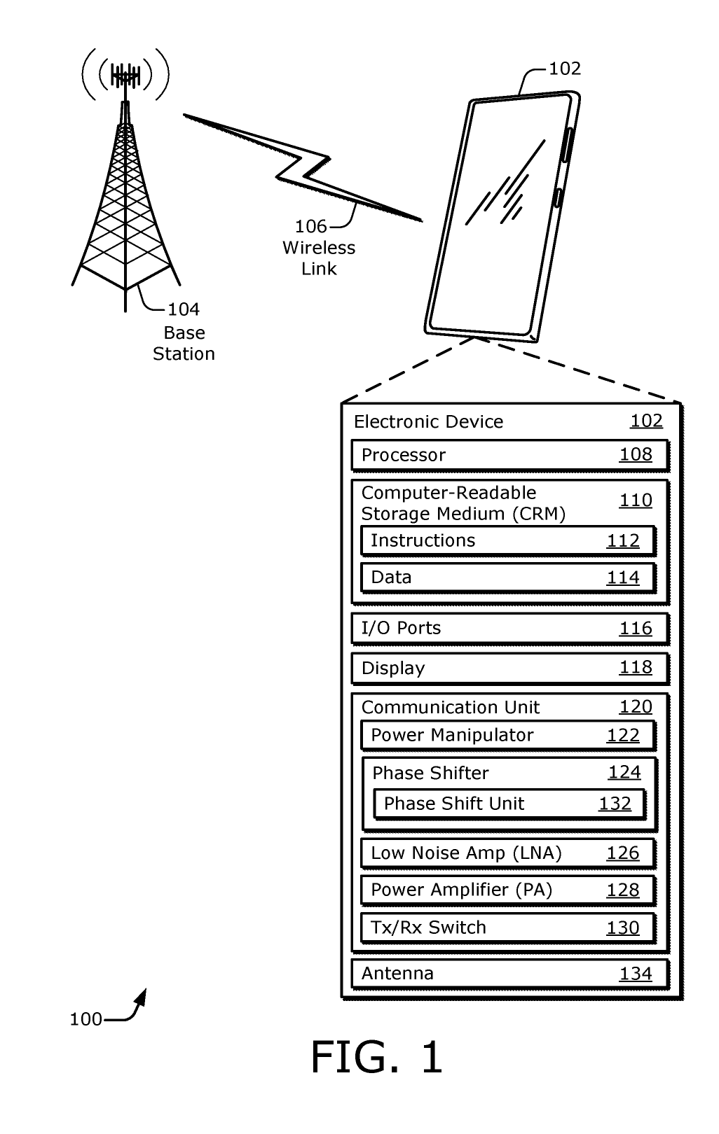

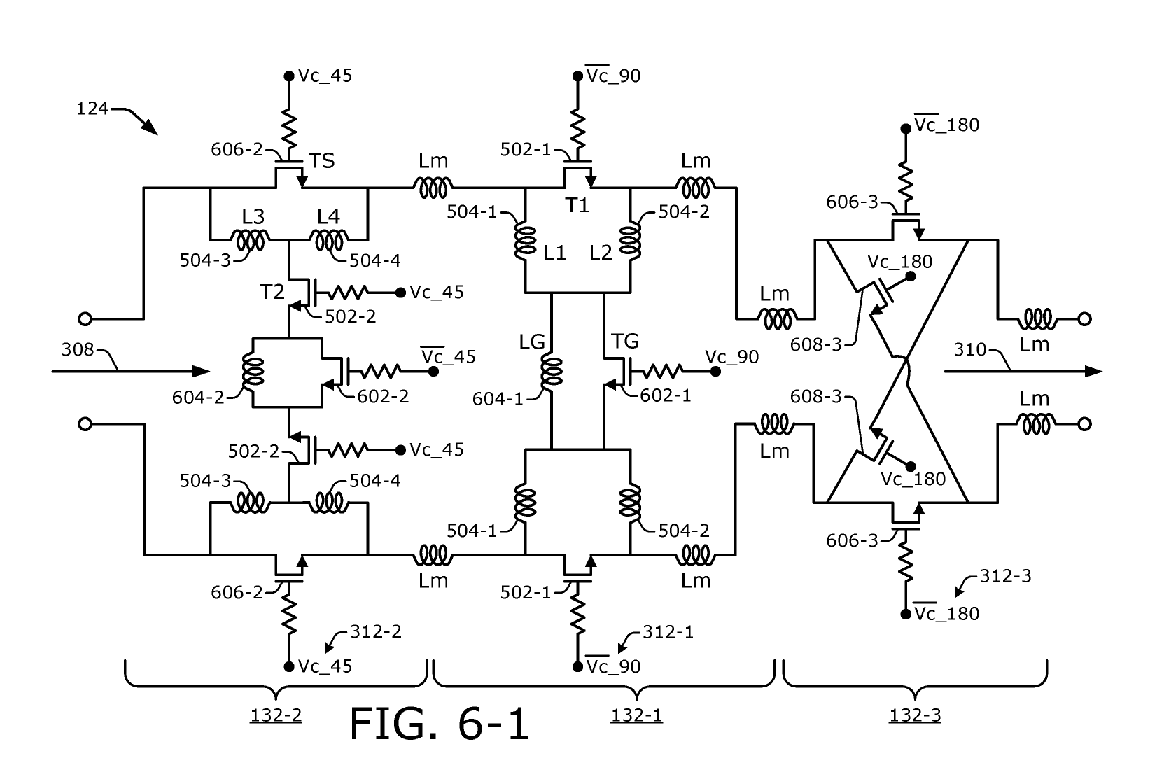

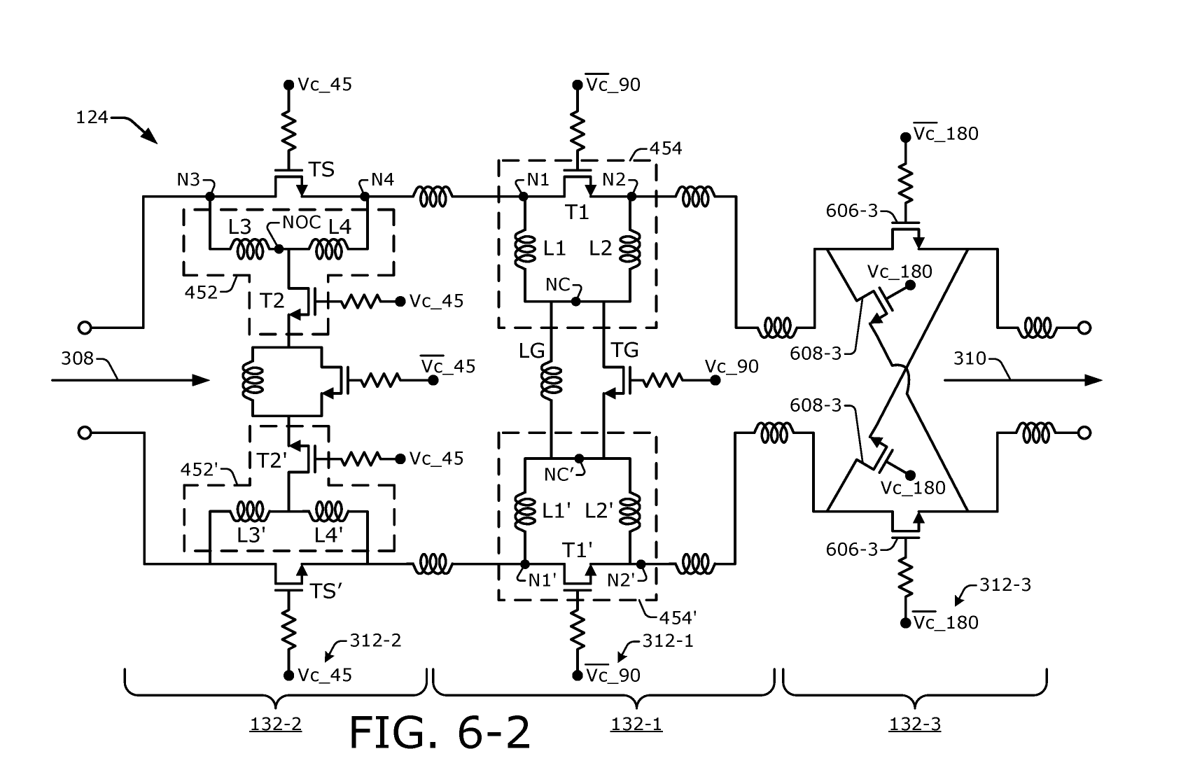

In other words, although both circuit topologies utilize an equivalent total inductance to realize an LC core, the high-pass pi-type circuit offers a lower insertion loss relative to the low-pass T-type circuit. Thus, employing the high-pass pi-type circuit solves the problem of the high insertion loss imposed by the low-pass T-type circuit while still enabling the use of a transistor in place of a capacitor, even for 90° phase shift amounts. In these manners, a passive phase shifter with multiple phase shift units can be implemented without relying on a traditional capacitor to provide an LC core. This is described further herein below, such as with reference to FIG. 6-1.

In certain aspects, an example phase shift unit is implemented to generate a 90° phase shift amount using a high-pass, pi-type circuit configuration to realize an LC core of the phase shift unit. Here, the pi-type circuit configuration of such an LC core includes two inductors as part of the two vertical legs of the pi-shape and a transistor having a parasitic capacitance to function like a capacitor as part of the top bar of the pi-shape. The transistor can be implemented using, for instance, a field effect transistor (FET). In the pi-type circuit configuration, a source terminal, a drain terminal, or both a source and a drain terminal of the FET can be electrically decoupled from the bulk or body of the FET. In a bypass operational mode for a given phase shift unit (e.g., if the phase shift unit is deactivated), the transistor is turned on to function like a resistor with some non-zero resistance to permit a signal to pass through without being substantially impacted by the inductors. In contrast, in a phase delay operational mode for the given phase shift unit (e.g., if the phase shift unit is activated), the transistor is turned off to function like a capacitor with a capacitive value determined based on desired performance characteristics. This capacitance, together with the inductance of the two inductors disposed along the vertical legs of the pi-type circuit configuration, creates an LC core that phase shifts transiting signals without using a metal capacitor (e.g., a traditional MIM or MOM capacitor) and with an acceptable level of insertion loss.

FIG. 1 illustrates an example environment 100 that includes a communication unit 120 in which a phase shifter 124 with at least one phase shift unit 132 can be implemented. The example environment 100 includes an electronic device 102 that communicates with a base station 104 through a wireless link 106. In this example, the electronic device 102 is depicted as a smart phone. However, the electronic device 102 may be implemented as any suitable computing or other electronic device, such as a modem, cellular base station, broadband router, access point, cellular phone, gaming device, navigation device, media device, laptop computer, desktop computer, tablet computer, server, network-attached storage (NAS) device, smart appliance, vehicle-based communication system, Internet-of-Things (IoT) device, wireless gateway, medical device, wearable computing device, and so forth.

The base station 104 communicates with the electronic device 102 via the wireless link 106, which may be implemented as any suitable type of wireless link. Although depicted as a base station tower of a cellular radio network, the base station 104 may represent or be implemented as another device, such as a satellite, cable television head-end, terrestrial television broadcast tower, access point, peer-to-peer device, mesh network node, fiber optic line, electronic device generally, and so forth. Hence, the electronic device 102 may communicate with the base station 104 or another device via a wired connection, a wireless connection, or a combination thereof.

The wireless link 106 can include a downlink of data or control information communicated from the base station 104 to the electronic device 102 and an uplink of other data or control information communicated from the electronic device 102 to the base station 104. The wireless link 106 may be implemented using any suitable communication protocol or standard, such as 3rd Generation Partnership Project Long-Term Evolution (3GPP LTE), 3GPP Fifth Generation (5G), IEEE 802.11, IEEE 802.16, Bluetooth™, and so forth.

The electronic device 102 includes at least one processor 108 and at least one computer-readable storage medium 110 (CRM 110). The processor 108 may be realized using any type of processor, such as an application processor or multi-core processor, that is configured to execute processor-executable instructions (e.g., code) stored by the CRM 110. The CRM 110 may include any suitable type of data storage media, such as volatile memory (e.g., random access memory (RAM)), non-volatile memory (e.g., Flash memory), optical media, magnetic media (e.g., disk or tape), and so forth. In the context of this disclosure, the CRM 110 is implemented to store instructions 112, data 114, and other information of the electronic device 102. The CRM 110 therefore does not include transitory propagating signals or carrier waves.

The electronic device 102 may also include one or more input/output ports 116 (I/O ports 116) or at least one display 118. The I/O ports 116 enable data exchanges or interaction with other devices, networks, or users. The I/O ports 116 may include serial ports (e.g., universal serial bus (USB) ports), parallel ports, audio ports, infrared (IR) ports, and so forth. The display 118 presents graphics of the electronic device 102, such as a user interface associated with an operating system, program, or application. Alternatively or additionally, the display 118 may be implemented as a display port or virtual interface through which graphical content of the electronic device 102 is communicated or presented.

For communication purposes, the electronic device 102 also includes a communication unit 120 and an antenna 134. The communication unit 120 provides connectivity to one or more respective networks and other electronic devices connected therewith. The communication unit 120 may facilitate communication over any suitable type of wireless network, such as a wireless local area network (LAN) (WLAN), a peer-to-peer (P2P) network, a mesh network, a cellular network, a wireless wide-area-network (WAN) (WWAN), and/or a wireless personal-area-network (WPAN). In the context of the example environment 100, a wireless implementation of the communication unit 120 enables the electronic device 102 to communicate with the base station 104 and networks connected therewith. Additionally or alternatively, the electronic device 102 may include a wired implementation of the communication unit 120 (e.g., with a wired transceiver), such as an Ethernet or fiber optic interface for communicating over a wired personal or local area network, an intranet, or the Internet.

The communication unit 120 includes circuitry and logic for transmitting or receiving a communication signal for at least one communication frequency band via the wireless link 106. In operation, the communication unit 120 can implement at least one, e.g., radio frequency (RF) transceiver to process data and/or signals associated with communicating data of the electronic device 102 via the antenna 134. For example, the communication unit 120 can include at least one baseband modem or other communication-oriented processor (not explicitly shown in FIG. 1). The baseband modem may be implemented as a system on-chip (SoC) that provides a digital communication interface for data, voice, messaging, and other applications of the electronic device 102. The baseband modem may also include baseband circuitry to perform high-rate sampling processes that can include analog-to-digital conversion (ADC), digital-to-analog conversion (DAC), gain correction, skew correction, frequency translation, and so forth.

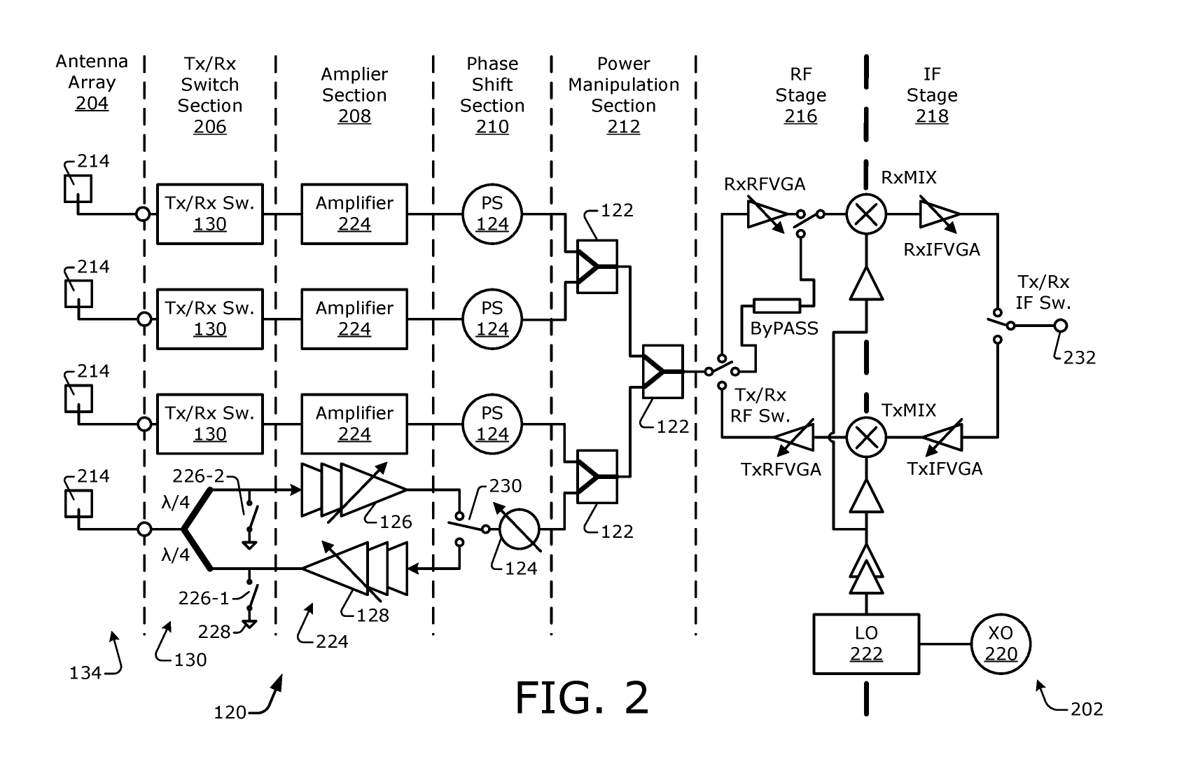

Generally, the communication unit 120 can include band-pass or other filters, switches, amplifiers, mixers, N-plexers, and so forth for routing and conditioning signals that are transmitted or received via the antenna 134. Examples of switches, amplifiers, mixers, and so forth are described below with reference to FIG. 2. As shown in FIG. 1, in addition to the phase shifter 124, the communication unit 120 may include the following: at least one power manipulator 122, at least one low-noise amplifier 126 (LNA 126), at least one power amplifier 128 (PA 128), and at least one transmit/receive switch 130 (Tx/Rx switch 130). Using these components, the communication unit 120 can provide wireless signals to, and obtain wireless signals from, the antenna 134. In some embodiments, the antenna 134 comprises a plurality of antenna elements and/or the electronic device 102 includes a plurality of antennas 134.

Here, the phase shifter 124 includes at least one phase shift unit 132. A phase shift unit 132 can include at least one inductive-capacitive core (LC core) (not shown in FIG. 1). The phase shifter 124, using one or more of the LC cores of multiple phase shift units 132, can delay a version of a signal to provide a phase-shifted communication signal version to an individual antenna element of an antenna array for the generation of signal beams using an antenna beamformer. Each respective antenna element may be associated with a respective phase shifter 124. The communication unit 120 may also include logic to perform in-phase/quadrature (I/Q) operations, such as synthesis, encoding, decoding, modulation, and demodulation.

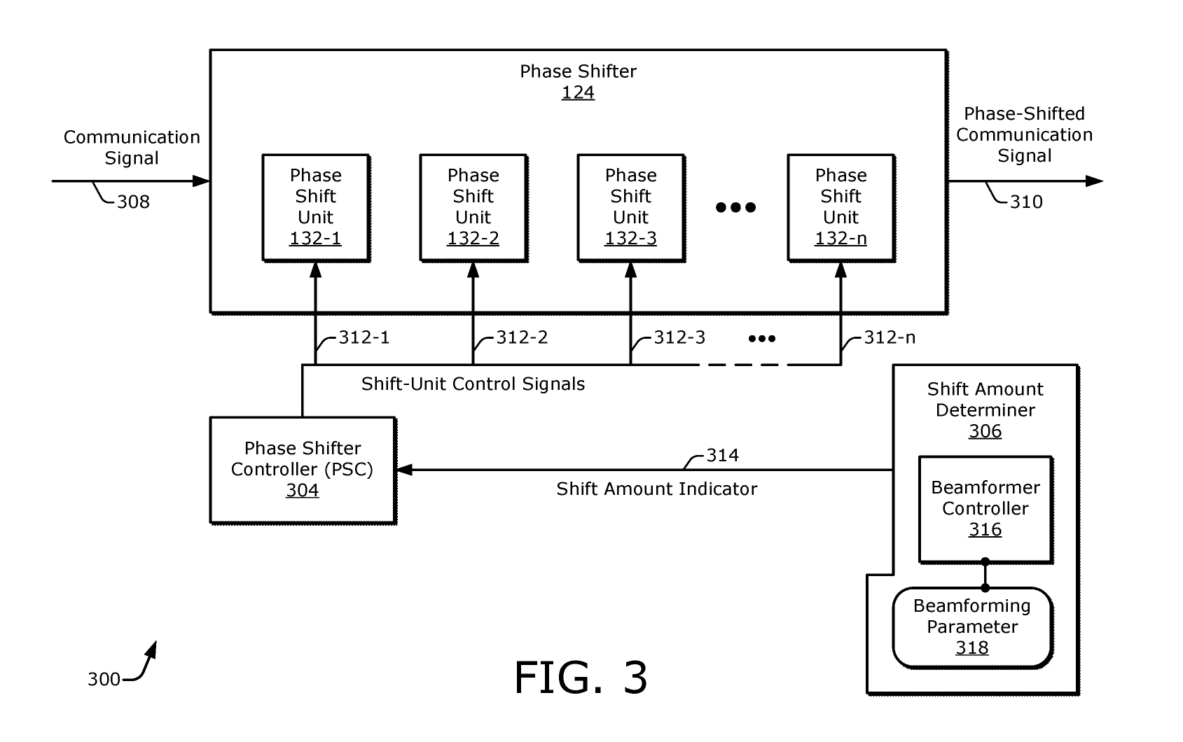

In some cases, components of the communication unit 120 are fully or partially implemented as separate receiver and transmitter entities. Additionally or alternatively, the communication unit 120 can be realized using multiple or different sections to implement respective receiving and transmitting operations (e.g., using at least partially separate receive and transmit chains). Example operations of, as well as interactions between, the power manipulator 122, the phase shifter 124, the LNA 126, the PA 128, and the Tx/Rx switch 130 are described below with reference to FIG. 2. As described further starting with FIG. 3, the phase shifter 124 can at least partially implement a phase shifter with multiple phase shift units 132 that are switchable to provide different combined phase shift amounts for a version of a communication signal.

FIG. 2 illustrates an example of the communication unit 120 that includes multiple phase shifters 124. The multiple phase shifters 124 can be incorporated into a transmit or receive chain or both using at least one switch 230, as depicted in a phase shift section 210. Although a switch 230 is explicitly shown with respect to only one phase shifter 124 along one antenna element path for clarity, a switch 230 can be deployed with each phase shifter 124 of the phase shift section 210. As indicated in the top right of FIG. 2, the communication unit 120 includes at least two stages: an RF stage 216 and intermediate frequency (IF) stage 218 (IF stage 218). Frequency conversion circuitry 202 separates the two stages and converts signal frequencies between RF and IF. Although not shown, the communication unit 120 can also include at least a baseband stage (BB stage) with at least one baseband processor (e.g., a modem or portion thereof). Further, a communication unit 120 may include more or fewer than two or three stages and corresponding frequencies for a transmit or receive signal. For example, in some embodiments the IF stage 218 is omitted and signals are upconverted from baseband directly to RF and/or down-converted from RF directly to baseband.

The frequency conversion circuitry 202 includes, proceeding clockwise from the top right thereof, the following: a receive IF variable gain amplifier (VGA) (RxIFVGA), a transmit/receive (Tx/Rx) switch at IF (Tx/Rx IF Sw.) that can function as a terminal for coupling a transmit or receive IF signal to/from a baseband processor, a transmit IF VGA (TxIFVGA), a transmit mixer (TxMIX), a transmit RF VGA (TxRFVGA), a Tx/Rx switch at RF (Tx/Rx RF Sw.), a receive RF VGA (RxRFVGA), and a receive mixer (RxMIX). The RF stage 216 also includes an amplifier bypass (ByPASS) that is available to bypass the receive RF VGA (RxRFVGA). Further, the frequency conversion circuitry 202 includes a crystal oscillator 220 (XO 220) and a local oscillator 222 (LO 222) that provide a mixer signal having a mixing frequency to the transmit mixer (TxMIX) and the receive mixer (RxMIX) via one or more buffers. For a receive signal, the receive mixer (RxMIX) down-converts an RF receive signal to an IF receive signal using the mixer signal provided by the LO 222. For a transmit signal, the transmit mixer (TxMIX) upconverts an IF transmit signal to an RF transmit signal using the mixer signal from the LO 222.

The RF stage 216 includes multiple example sections, as well as an antenna array 204 on the left of FIG. 2. Starting from the antenna array 204, and moving rightward, example sections include the following: a Tx/Rx switch section 206, an amplifier section 208, a phase shift section 210, and a power manipulation section 212. As shown, the antenna array 204 includes multiple antenna elements 214, each of which can transmit or receive a respective version of a communication signal for beamforming purposes. Each antenna array 204 or antenna element 214 can be formed from a patch antenna, a bowtie antenna, a dipole antenna, a polarized antenna, some combination thereof, and so forth. Thus, the antenna 134 can comprise at least one antenna array 204, at least one antenna element 214, some combination thereof, and so forth. Although four antenna elements 214 are explicitly shown, a given antenna array 204 can include more or fewer than four antenna elements. Similarly, the communication unit 120 can include more or fewer than four signal paths extending between the power manipulation section 212 and the antenna array 204.

As illustrated, the Tx/Rx switch section 206 includes multiple Tx/Rx switches 130, and the amplifier section 208 includes multiple amplifiers 224. Each Tx/Rx switch 130 can include two signal paths. Each signal path of the Tx/Rx switch 130 includes a delay line (e.g., a quarter-wavelength (λ/4) delay line) and switches 226-1 and 226-2 that activate or deactivate a transmit signal path or a receive signal path, respectively. For example, to deactivate a given signal path, a switch 226, which is coupled between the given signal path and a ground 228, can be closed to short the signal path. Each amplifier 224 can provide an adjustable amplification. Further, each amplifier 224 can include an LNA 126 or a PA 128 (or, as indicated by the inclusive disjunctive “or,” both an LNA 126 and a PA 128). The phase shift section 210 includes multiple phase shifters 124. Examples of a phase shifter 124 are described below starting with FIG. 3.

The power manipulation section 212 includes multiple power manipulators 122. Each power manipulator 122 can function as a power combiner (e.g., for signal receiving operations) or as a power splitter (e.g., for signal transmitting operations). Thus, a power manipulator 122 may include a power combiner, a power splitter, or a combined power splitter and combiner. Instead of three two-to-one power manipulators, a different number may be implemented. For instance, a single four-to-one power manipulator may be equivalently deployed in the power manipulation section 212. As shown, a phase shifter 124 can be coupled between a power manipulator 122 and an amplifier 224. For example, a phase shifter 124 can be coupled to a power manipulator 122 on a communication-oriented processor side of a transmit or receive chain and can be switchably coupled to an amplifier 224 on an antenna side of the transmit or receive chain. The phase shifter 124 can be switchably coupled to, for instance, an LNA 126 for receive operations and a PA 128 for transmit operations. Generally, these sections 206-212 of the RF stage 216 and the components thereof, as well as the amplifiers and mixers of the frequency conversion circuitry 202, route signals between the antenna array 204 and a baseband processor of a baseband stage (not shown).

In example implementations, starting from the bottom left of FIG. 2 for a receive operation, a wireless signal is received at an antenna element 214. The Tx/Rx switch 130 closes the switch 226-1 to short the lower Tx path and opens the switch 226-2 for the upper Rx path. However, the Tx/Rx switch 130 may be implemented using any of a variety of alternative switch implementations. For example, the Tx/Rx switch section 206 or a Tx/Rx switch 130 thereof can be realized using at least one multiplexer, at least one switch matrix, and so forth. As shown, each signal path in the Tx/Rx switch section 206 can include a phase delay line, such as one that is one-quarter wavelength. The received signal is provided to at least one LNA 126. Although three LNA and PA stages are explicitly illustrated in FIG. 2, implementations may alternatively have fewer or more than three stages in each receive or transmit path, respectively. Further, these amplifiers may employ a fixed or an adjustable gain.

A switch 230 is placed in a state that routes the amplified received signal to the phase shifter 124 (e.g., a state that couples the phase shifter 124 to the upper receive path). The amplified received signal is phase shifted by the phase shifter 124. The phase-shifted signal is provided to a power manipulator 122. In the receive direction, the power manipulator 122 functions as a power combiner to combine incoming versions of the signal as received via different antenna elements 214. The receive chain continues on the upper half of the frequency conversion circuitry 202, which links or transitions between the RF stage 216 and the IF stage 218 using the receive mixer (RxMIX).

The local oscillator 222 may include a phase-locked loop (PLL) and a voltage-controlled oscillator (VCO) (not explicitly shown). The PLL and the VCO can use a crystal oscillator signal from the crystal oscillator 220 to produce a mixer signal having a desired mixing frequency for the receive mixer (RxMIX) and the transmit mixer (TxMIX). The receive mixer (RxMIX) performs a frequency down-conversion operation using the synthesized mixer signal from the local oscillator 222 to convert from an RF signal to an IF signal. The down-converted signal is then forwarded via the Tx/Rx IF switch (Tx/Rx IF Sw.) to a baseband processor (e.g., a modem or other communications-oriented processor—not shown) via the terminal 232. In some implementations, the down-converted signal is routed from the terminal 232 through a transceiver to downconvert the IF to baseband prior to being provided to the baseband processor. In some implementations, the Tx/Rx IF switch (Tx/Rx IF Sw.) is omitted and Tx IF and Rx IF signals are provided via respective ports, for example to/from such a transceiver. Although only one slice of circuitry is shown across FIG. 2, multiple slices may be implemented to enable simultaneous transmission or reception on other frequencies and/or to enable beamforming using a greater number of antenna elements 214 than are shown in FIG. 2 for the antenna array 214.

For an example transmit operation, a signal is obtained at the terminal 232 on the right of FIG. 2, e.g., from a baseband processor (possibly after being routed through a transceiver for up-conversion to IF). The signal is amplified twice, once each by the transmit IF VGA (TxIFVGA) and the transmit RF VGA (TxRFVGA). In between these amplifiers, the transmit mixer (TxMIX) performs a frequency up-conversion operation using the mixer signal synthesized by the PLL and VCO circuitry of the local oscillator 222 to convert from an IF signal to an RF signal. Although a single mixer symbol is shown as an upconverter or a downconverter in the transmit and receive chains, either or both of the mixers may perform frequency conversion in a single conversion step or through multiple conversion steps. The frequency up-converted signal is then forwarded from the Tx/Rx RF switch (Tx/Rx RF Sw.) to the power manipulation section 212.

In the transmit direction, the power manipulator 122 functions as a power splitter for the signal to be separated into different versions of the signal and then routed toward the antenna elements 214 as different signal portions. Continuing on the lower branch, the phase shifter 124 shifts a phase of the split signal that is to be transmitted by a designated phase shift amount. Using the switch 230, the phase-shifted signal is routed through one or more PAs 128. After amplification, the amplified, phase-shifted signal is routed along the lower transmit path of the Tx/Rx switch 130 and to the lowest antenna element 214 as part of an RF emanation that forms at least one signal beam.

Some implementations of the communication unit 120 illustrated in FIG. 2 may be implemented in, for example, a 28 GHz phased array transceiver with RF/IF conversion. Such implementations may be implemented in 28 nm bulk CMOS or a process of another size and/or may support up to, e.g., 12 antenna elements, each on two multiple-input, multiple-output (MIMO) layers. Although components and elements herein are partially described with respect to deployment with a mobile user equipment (e.g., a portable realization of the electronic device 102) and may be implemented in a transceiver targeted for small antenna arrays, certain designs may support tiling and/or extension of the concepts described herein to an antenna array sized for base station applications. Those of skill in the art will therefore understand that implementations that are described with respect to a portable electronic device 102 may also be realized in a base station 104 or another relatively large-scale implementation.

FIG. 3 illustrates an example phase shifter 124 including multiple phase shift units 132 that are controlled by a phase shifter controller 304 (PSC 304). The phase shifter 124 receives a communication signal 308 and produces a phase-shifted communication signal 310 based thereon using one or more of the multiple phase shift units 132. As shown, the phase shifter 124 includes “n” phase shift units 132-1, 132-2, 132-3 . . . 132-n, with “n” representing some positive integer. Each of the individual phase shift units 132 can shift the communication signal 308 by some phase shift amount to produce the phase-shifted communication signal 310 for a transmission or a reception operation.

In operation, the phase shifter controller 304 generates multiple shift-unit control signals 312-1, 312-2, 312-3 . . . 312-n. The phase shifter controller 304 provides the shift-unit control signals 312-1 . . . 312-n to respective ones of the phase shift units 132-1 . . . 132-n to individually control each phase shift unit 132. For example, each shift-unit control signal 312 can set a phase shift amount or turn on/off a respective phase shift unit 132. Thus, the phase shifter controller 304 can individually activate or deactivate each phase shift unit 132. If all of the phase shift units 132-1 to 132-n are deactivated based on the shift-unit control signals 312-1 to 312-n, the phase shifter 124 can output a non-phase-shifted communication signal 310.

A shift amount determiner 306 informs the phase shifter controller 304 of a designated or desired phase shift amount via a shift amount indicator 314. The shift amount indicator 314 can indicate, for instance, a total desired phase shift amount across the phase shifter 124 or individual phase shift amounts. The phase shifter controller 304 then adjusts the shift-unit control signals 312-1 to 312-n to produce the total desired phase shift or drives the shift-unit control signals 312-1 to 312-n responsive to the individual phase shift amounts. One phase shifter controller 304 can control multiple phase shifters 124 (e.g., for the multiple phase shifters 124 of at least one antenna array 204 of FIG. 2), or each phase shifter controller 304 may control an associated respective phase shifter 124. The shift amount determiner 306 or the phase shifter controller 304 can be implemented in a baseband stage (e.g., a modem or other communication-oriented processor). Alternatively, the shift amount determiner 306 or the phase shifter controller 304 can be implemented in the IF stage 218 or the RF stage 216 (of FIG. 2). The shift amount determiner 306 and the phase shifter controller 304 can be implemented in the same stage or in different stages.

The phase shifter 124 can shift phases of signals in different environments and for multiple purposes. However, one example purpose is antenna beamforming In such a scenario, a beamformer controller 316 determines at least one beamforming parameter 318, such as one or more phase shifts for respective ones of different versions of a signal to be transmitted or received to produce an intended signal beam (e.g., a desired beam pattern or direction). The phase shift amount is determined for each phase shifter 124 that is coupled to an antenna 134 (of FIG. 2) that is being used to transceive a signal (e.g., used to transmit or receive a signal). The corresponding shift amount indicator 314 is then provided to the phase shifter controller 304. The phase shifter controller 304 decodes the shift amount indicator 314 and makes the shift-unit control signals 312-1 to 312-n active or inactive responsive to the decoding to activate or deactivate, respectively, a given phase shift unit 132-1 to 132-n.

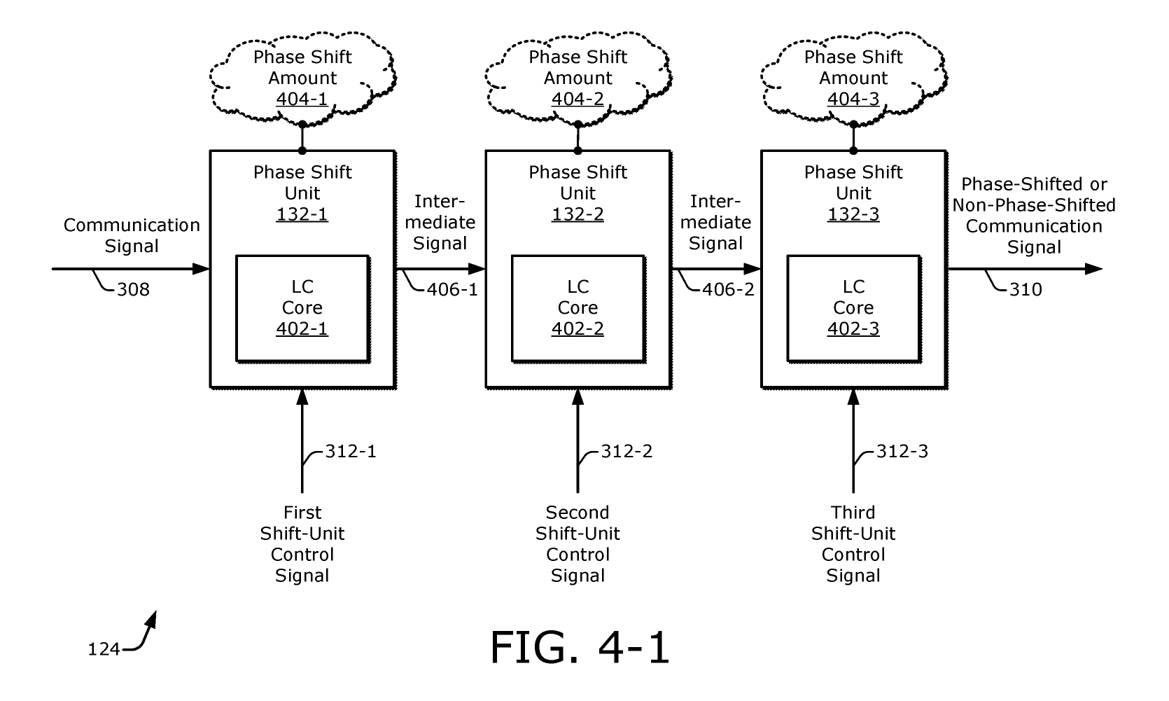

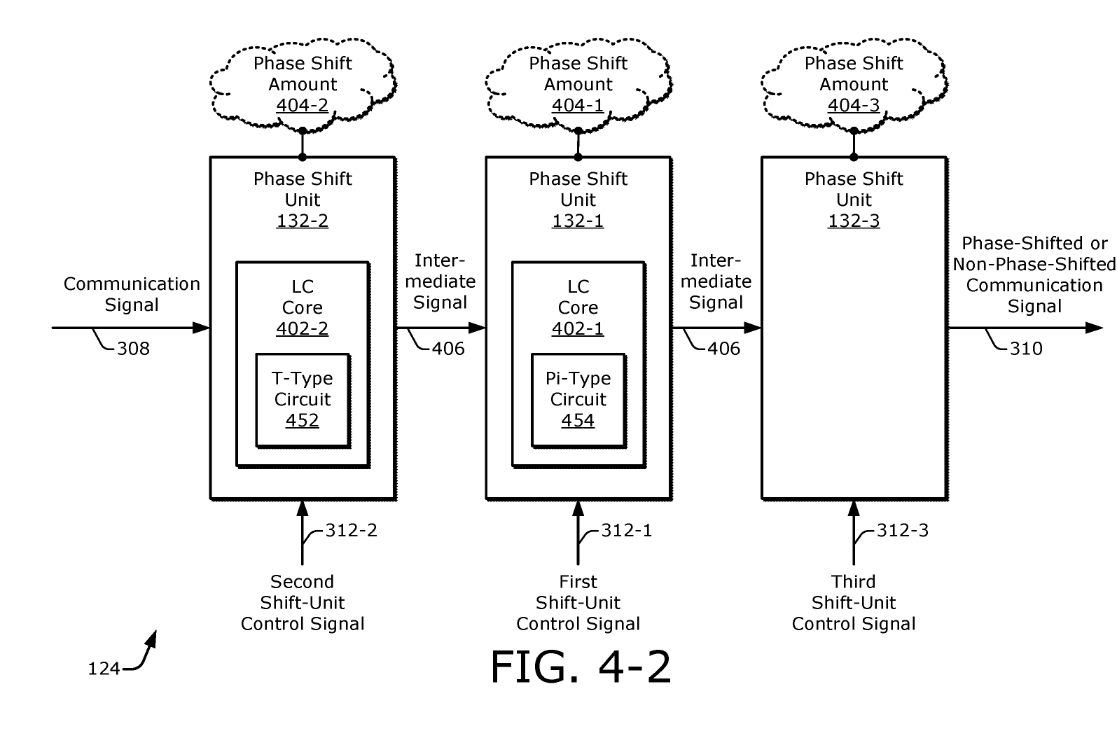

FIG. 4-1 illustrates, for a phase shifter 124, an example implementation having three phase shift units 132-1 to 132-3, each of which may include an inductive-capacitive (LC) core 402 (LC core 402). As shown, each respective phase shift unit 132-1, 132-2, and 132-3 includes a respective LC core 402-1, 402-2, and 402-3. However, an individual phase shift unit 132 may alternatively be realized without an LC core 402 or with multiple LC cores. In operation, each phase shift unit 132 can shift a transiting signal by a phase shift amount 404 that is determined at least partly by inductance and capacitance values of the respective LC core 402. Also, although three phase shift units 132-1 to 132-3 are shown in FIG. 4-1, more or fewer can alternatively be implemented.

In example implementations, a signal traverses the phase shifter 124 by propagating between adjacent phase shift units. The phase shift units 132-1 to 132-3 are coupled together in series in a chained arrangement in which a propagating signal transits each phase shift unit 132 in consecutive order (e.g., in either direction: from 132-1 to 132-3 or from 132-3 to 132-1). Each respective phase shift unit 132-1, 132-2, and 132-3 that is currently activated shifts a transiting signal by a respective phase shift amount 404-1, 404-2, and 404-3. Each activated phase shift unit 132 shifts an incoming signal and outputs a phase-shifted signal to a succeeding phase shift unit 132. The succeeding phase shift unit 132 therefore accepts the phase-shifted signal from the preceding phase shift unit 132 and then further shifts the signal. Thus, adjacent phase shift units 132 receive a signal, shift the phase thereof if the unit is activated, and output a phase-shifted signal. Adjacent phase shift units 132 pass an intermediate signal 406 across internal junctions between any two phase shift units. In this manner, each phase shift amount that is applied to the signal is cumulative across the chained arrangement of phase shift units 132-1 to 132-3 between the communication signal 308 and the phase-shifted communication signal 310.

In an example operation, a first phase shift unit 132-1 receives the communication signal 308, shifts the incoming signal (if the first unit is activated), and passes a first intermediate shifted signal 406-1 to a second phase shift unit 132-2. The second phase shift unit 132-2 receives the first intermediate shifted signal 406-1, shifts that incoming signal (if the second unit is activated), and outputs a second intermediate shifted signal 406-2. The third phase shift unit 132-3 receives the second intermediate shifted signal 406-2, shifts that incoming signal (if the third unit is activated), and outputs the phase-shifted communication signal 310. If any of the phase shift units 132-1 to 132-3 are deactivated, the deactivated phase shift unit 132 passes the signal to the succeeding unit (or to the output) without producing a shift on the signal—e.g., as an intermediate non-shifted signal 406.

The first, second, and third phase shift units 132-1, 132-2, and 132-3 are respectively controlled by first, second, and third shift-unit control signals 312-1, 312-2, and 312-3. Each shift-unit control signal 312 can set a phase shift amount 404 by controlling an associated phase shift unit 132. In some implementations, a respective shift-unit control signal 312 can adjust the corresponding phase shift amount 404 across a range of phase shift amounts. In other implementations, the shift-unit control signal 312 adjusts the corresponding phase shift amount 404 between two values, such as a null phase shift amount (0°) and a predetermined phase shift amount (e.g., 22.5°, 45°, 90°, 120°, or 180°). In other words, a given shift-unit control signal 312 can turn on or activate a given phase shift unit 132 to institute a delay/phase shift or can turn off or deactivate the given phase shift unit 132 to pass a signal without adding any appreciable delay/phase shift. To do so, each shift-unit control signal 312 may be coupled to an activation circuit (not shown in FIG. 4-1) of a respective phase shift unit 132.

FIG. 4-2 illustrates, for the phase shifter 124 of FIG. 4-1, multiple phase shift units 132-1 to 132-3, each of which may include a different example type of circuit topology for an LC core 402 thereof. Here, the order of the phase shift units 132 have been rearranged as compared to the order of FIG. 4-1 to better match the illustrated circuitry of FIGS. 6-1 and 6-2. From left to right, the phase shift units are ordered as follows: the second phase shift unit 132-2, the first phase shift unit 132-1, and the third phase shift unit 132-3. As shown, the first phase shift unit 132-1 includes a first LC core 402-1, and the second phase shift unit 132-2 includes a second LC core 402-2. The third phase shift unit 132-3, however, does not include an LC core. Thus, the third phase shift unit 132-3 can perform a phase shift operation without using an LC core 402.

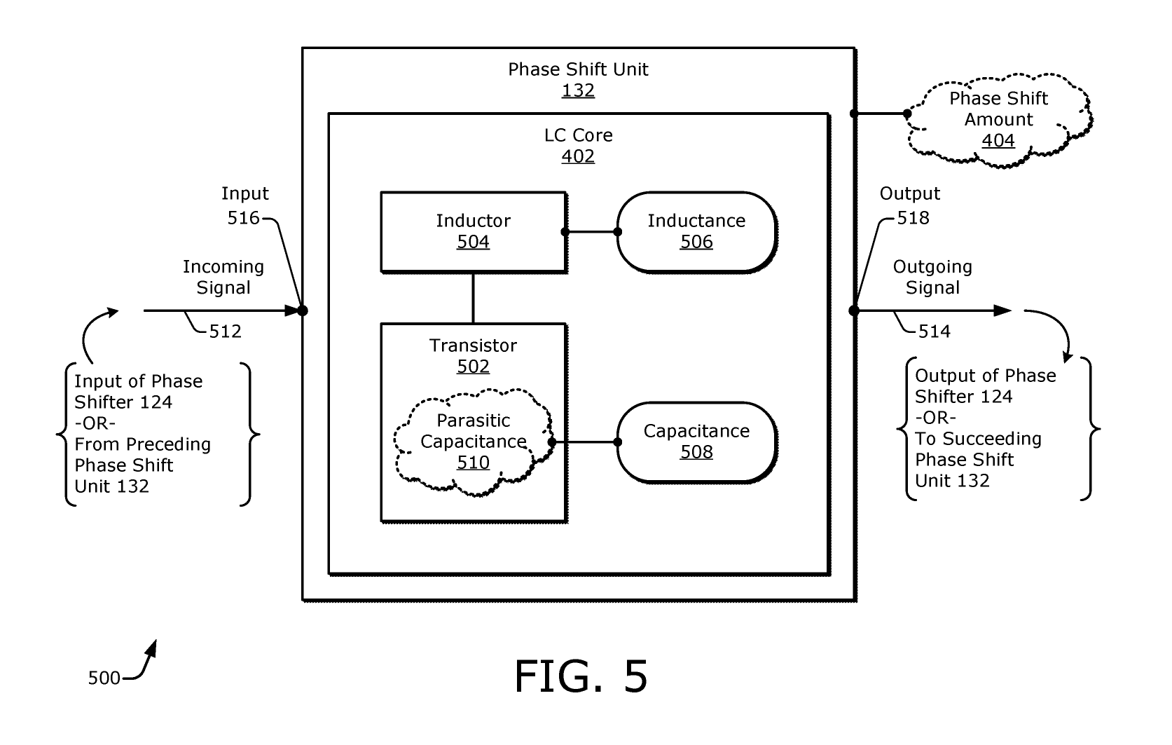

In some example implementations, the first LC core 402-1 of the first phase shift unit 132-1 includes or is realized using a pi-type circuit 454. In contrast, the second LC core 402-2 of the second phase shift unit 132-2 includes or is realized using a T-type circuit 452. A T-type circuit 452 has a topology including a top bar of a T-shape and a vertical post of the T-shape. The top bar includes two components, one on either side of a junction (e.g., a tap node) coupling the top bar and the vertical post. The vertical post includes a third component. A pi-type circuit 454 has a topology including a top bar of a pi-shape and two vertical legs of the pi-shape. The top bar includes one component. A vertical leg extends “downward” on each side of the component disposed along the top bar. Each vertical leg includes another component. Thus, both the T-type circuit 452 and the pi-type circuit 454 can include three components selected from inductive and capacitive elements. However, an LC core 402 can be formed from a different circuit type, and a T-type circuit 452 or a pi-type circuit 454 can include a different number of components than three. An example circuit structure is described below with reference to FIGS. 6-1 and 6-2. Examples of inductive and capacitive elements are described with reference to FIG. 5.

FIG. 5 illustrates a phase shift unit 132 including an example LC core 402 having at least one transistor 502 and at least one inductor 504. The phase shift unit 132 includes an input 516 and an output 518. The phase shift unit 132 receives an incoming signal 512 via the input 516 and selectively provides an outgoing phase-shifted signal 514 or an outgoing non-phase-shifted signal 514 via the output 518. The incoming signal 512 can correspond to the input of the phase shifter 124 (e.g., the communication signal 308 of FIGS. 3, 4-1, and 4-2) or an intermediate signal 406 from an adjacent, preceding phase shift unit 132. The outgoing signal 514 can correspond to the output of the phase shifter 124 (e.g., the phase-shifted or non-phase-shifted communication signal 310) or an intermediate signal 406 provided to an adjacent, succeeding phase shift unit 132. Thus, in an example operation, circuitry of the LC core 402 is configured to phase shift the incoming signal 512 to produce an outgoing phase-shifted signal 514 as the signal transits the phase shift unit 132. Alternatively, the phase shift unit 132 may pass the incoming signal 512 through without shifting its phase to provide an outgoing non-phase-shifted signal 514.

In example implementations, the inductor 504 is coupled to the transistor 502 in the LC core 402. The LC core 402 performs the phase shifting using an inductance 506 and a capacitance 508. The inductor 504 is configured to provide the inductance 506. However, instead of a traditional capacitor (e.g., instead of a MIM or MOM capacitor), the transistor 502 is configured to provide the capacitance 508. More specifically, the transistor 502 is configured to provide a capacitive effect using a parasitic capacitance 510 of the transistor 502. In some implementations, at least one respective transistor 502 is configured to provide the capacitance 508 for each respective LC core 402 included in the multiple phase shift units 132-1 to 132-2 or 132-1 to 132-n (e.g., of FIGS. 3, 4-1, and 4-2), such as for two or more (including up to all) such phase shift units 132.

The parasitic capacitance 510 arises from different portions of the transistor 502 that have different voltage levels or different amounts of charge during operation. In some implementations, the transistor 502 is implemented as a field effect transistor (FET) having a gate terminal, a source terminal, and a drain terminal. The FET can also be associated with a body terminal or bulk node. Examples of parasitic capacitance 510 for FETs include: a capacitance between the gate and drain, a capacitance between the gate and source, a capacitance between the source and drain, a capacitance between the gate and body, a capacitance between the source and body, a capacitance between the drain and body, and so forth. Other examples of parasitic capacitance 510 for FETs include a capacitance between the bulk and well, intrinsic capacitances, and so forth.

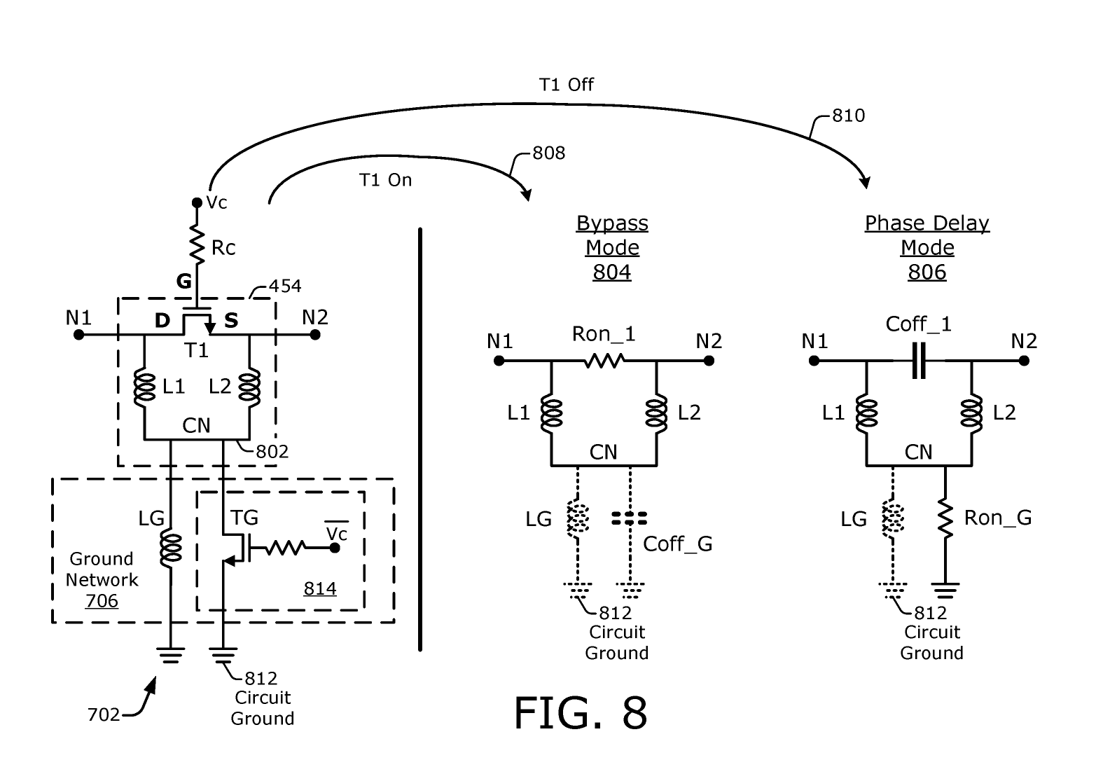

FIG. 6-1 illustrates example circuitry for a phase shifter 124 having three phase shift units 132-1 to 132-3, each of which corresponds to a different phase shift amount 404 (of FIG. 4). The example circuitry of FIG. 6-1 is implemented using differential signaling. However, certain principles as described herein are likewise applicable to single-ended signaling, an example of which is described below with reference to FIG. 8.

In the illustrated example, the first phase shift unit 132-1 produces a 90° phase shift, the second phase shift unit 132-2 produces a 45° phase shift, and the third phase shift unit 132-3 produces a 180° phase shift. Each transistor 502 (e.g., transistors 502-1 and 502-2) can be configured to provide a capacitance 508 to an LC core 402 as described above with reference to FIG. 5. The first phase shift unit 132-1 includes two first transistors 502-1. The second phase shift unit 132-2 includes two second transistors 502-2. The third phase shift unit 132-3, however, does not include a transistor 502 that is implemented to provide a capacitance 508 as part of an LC core.

By way of example, each of the transistors 502 is implemented as an n-type metal-oxide-semiconductor (MOS) (NMOS) FET. However, any one or more of the transistors 502 can be implemented using a different transistor type (e.g., a PMOS FET or a junction field effect transistor (JFET)), and individual ones of the multiple transistors 502 can differ from one another. The multiple phase shift units 132-1 to 132-3 can be arranged in any order and can be coupled to other circuit components via any phase shift unit 132. However, in some implementations, the 180° phase shift unit 132-3 may be placed closest to a power amplifier (e.g., the PA 128 of FIG. 2) to increase transmit mode linearity. Note also that although the communication signal 308 and the phase-shifted communication signal 310 implicitly indicate an example signal direction, the phase shifter 124 can be operated bidirectionally whereby the communication signal 308 arrives at the third phase shift unit 132-3 and the phase-shifted communication signal 310 exits at the second phase shift unit 132-2.

In example implementations, each phase shift unit 132 includes multiple transistors, each of which is biased by a control voltage Vc. The control voltage Vc can be applied to a gate of each transistor via a bias resistor, some of which are explicitly depicted in FIG. 6-1. Some of the transistors (e.g., the transistors 502) can be turned off to utilize the parasitic capacitance 510 thereof as part of an LC core 402, which is described below. The first and second phase shift units 132-1 and 132-2 also include multiple inductors, some of which can be used to form part of each LC core (e.g., the inductors 504-1 to 504-4). These LC cores are explicitly indicated in FIG. 6-2 with the T-type circuit 452 and the pi-type circuit 454, as is described below. Also depicted is that at least one matching inductor Lm can separate adjacent phase shift units.

As shown in FIG. 6-1, the shift-unit control signals 312-1 to 312-3 are implemented using a control voltage Vc. The first shift-unit control signal 312-1 corresponds to the first control voltage Vc_90, the second shift-unit control signal 312-2 corresponds to the second control voltage Vc_45, and the third shift-unit control signal 312-3 corresponds to the third control voltage Vc_180. These control voltage Vc signals, including their inverted or “bar” versions, turn the transistors on and off, e.g., to selectively deactivate or activate the corresponding phase shift unit 132. The control voltage Vc signals are therefore coupled to gate terminals of the transistors via a bias resistor. A channel terminal (e.g., a drain terminal or a source terminal) of each of the transistors is coupled to another component as is described below.

With regard to the second phase shift unit 132-2, a channel of a switch transistor 606-2 (TS) is coupled in parallel with the series-connected inductors 504-3 and 504-4. Thus, the inductor 504-4 (L4) is coupled to a source of the switch transistor 606-2, and the inductor 504-3 (L3) is coupled to a drain of the switch transistor 606-2. A transistor 502-2 (T2) is coupled between a node that is in common with both of the inductors 504-3 and 504-4 (e.g., like a central tap node) and another node. Coupled to this other node are an inductor 604-2 and a transistor 602-2, which are coupled together in parallel. The inductor 604-2 and the transistor 602-2 provide a virtual ground between the plus and minus portions of the second phase shift unit 132-2 for plus and minus portions of a differential realization of the communication signal 308. The other four components (as depicted in the lower portion) of the second phase shift unit 132-2 are similar to those described above with respect to the upper portion, and may be structured as a mirror image of those described above, to enable differential signaling.

With regard to the first phase shift unit 132-1, respective channel terminals of the transistor 502-1 (T1) are coupled to the inductor 504-1 (L1) and the inductor 504-2 (L2), respectively. Thus, the inductor 504-1 is coupled to a drain terminal of the transistor 502-1, and the inductor 504-2 is coupled to a source terminal of the transistor 502-1. A transistor 602-1 (TG) is coupled to a node that is in common with both of the inductors 504-1 and 504-2 (e.g., like a central tap node). Also coupled to this common node is an inductor 604-1 (LG). Here, the inductor 604-1 and the transistor 602-1 are coupled together in parallel. Further, the inductor 604-1 and the transistor 602-1 provide a virtual ground between the plus and minus portions of the first phase shift unit 132-1 for plus and minus portions of a differential realization of the communication signal 308. The other three components (as depicted in the lower portion) of the first phase shift unit 132-1 are similar to those described above with respect to the upper portion, and may be structured as a mirror image of those described above, to enable differential signaling.

With regard to the third phase shift unit 132-3, a channel of a transistor 606-3 extends between incoming and outgoing nodes for one polarity of a differential signal, and a channel of another transistor 606-3 extends between incoming and outgoing nodes for another polarity of the differential signal. Further, a channel of a transistor 608-3 extends between an incoming node for one polarity and an outgoing node for the other polarity of the differential signal. Similarly, a channel of another transistor 608-3 extends between an incoming node for the other polarity and an outgoing node for the one polarity of the differential signal. Thus, the two transistors 608-3 form a pair of transistors that are cross-coupled across the third phase shift unit 132-3.

For the third phase shift unit 132-3, the transistors 606-3 and 608-3 can be configured to pass signals with low resistance if turned on without compensating for inductors that are connected directly thereto. Further, the transistors 606-3 and 608-3 can be configured to block signals while exhibiting a low capacitance if turned off. For the second phase shift unit 132-2, the switch transistor 606-2 (TS) can be configured to have a small resistance if turned on and also a small capacitance if turned off. For example, a smallest on-resistance and a smallest off-capacitance that are feasible may be implemented given process restraints. In contrast, for the first phase shift unit 132-1, the first transistor 502-1 (T1) can be configured to have a small resistance if turned on but a targeted capacitance if turned off. A capacitance value that is targeted for the first transistor 502-1 (T1) is based on an operational frequency and a desired phase shift, as described herein below with reference to Equation (2). With transistors, an off capacitance value depends partly on an operating frequency. For example, in the 30 GHz range, the first transistor 502-1 (T1) may have a capacitance of approximately 120 fF. On the other hand, the switch transistor 606-2 (TS) while operating in the 30 GHz range may have a capacitance of approximately 30-40 fF. Thus, at 30 GHz, some transistors having an off capacitance over approximately 60 fF may be used as part of an LC core. With regard to the ground transistor 602-1 (TG), a small on-resistance and an off-capacitance that is based on the resonant frequency provided by the ground inductor 604-1 (LG) may be used. One of ordinary skill would be able to design suitable transistors with these characteristics given the above constraints and the description related to Equation (2) below.

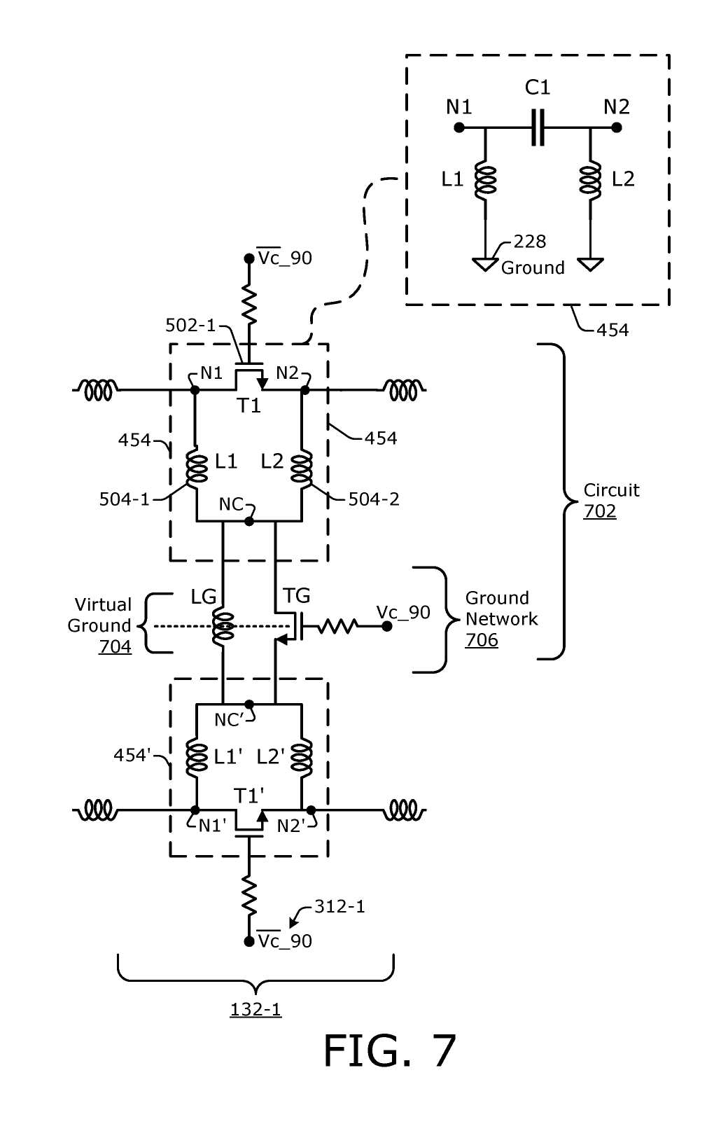

For the first (e.g., 90°) phase shift unit 132-1, the phase shifter controller 304 (of FIG. 3) turns the transistors 502-1 on to implement a bypass mode and thereby deactivate the first phase shift unit 132-1. On the other hand, the phase shifter controller 304 turns the transistors 502-1 off to activate the first phase shift unit 132-1 and thereby implement a phase shift mode. As explained below with reference to FIGS. 7 and 8, turning the transistor 502-1 off causes the transistor 502-1 to provide a capacitance for an LC core of the first phase shift unit 132-1. For the third (e.g., 180°) phase shift unit 132-3, the transistors 606-3 are turned on and the transistors 608-3 are turned off to implement a bypass mode and thereby deactivate the third phase shift unit 132-3. To activate the third phase shift unit 132-3 and implement a phase shift mode, the phase shifter controller 304 turns off the transistors 606-3 and turns on the transistors 608-3 to “swap” the plus and minus portions of the differential signal to “flip” the phase thereof 180°.

For the second (e.g., 45°) phase shift unit 132-2, for deactivation of the unit and to implement a bypass mode, the phase shifter controller 304 turns on the transistors 606-2 and can also turn on the transistors 502-2. Here, the transistor 606-2 is implemented to function as a transistor switch at the operational frequency of interest. Thus, if the transistor 606-2 is turned on, a signal can propagate across a channel thereof while remaining substantially unchanged by the inductors 504-3 and 504-4. On the other hand, for activation of the second phase shift unit 132-2 and to implement a phase shift mode, the phase shifter controller 304 turns off both the transistors 606-2 and the transistors 502-2. With the transistor 606-2 functioning as an open switch, a signal that transits the second phase shift unit 132-2 propagates through the inductors 504-3 and 504-4. Further, the transistor 502-2 is implemented to provide a capacitance 508 for the LC core of the second phase shift unit 132-2 at the operational frequency using the parasitic capacitance 510 thereof if the transistor 502-2 is switched off. This transistor 502-2 therefore also impacts a phase of the transiting signal. For example, the transistor 502-2, in conjunction with the inductors 504-3 and 504-4, can provide a 45° phase shift.

As can be determined based on the description above, when both of the phase shift units 132-2 and 132-1 illustrated in FIG. 6-1 are deactivated, a signal primarily propagates through the transistors 606-2 (TS) and 502-1 (T1), respectively. When both of the phase shift units 132-2 and 132-1 illustrated in FIG. 6-1 are activated, however, a difference in their respective operations may include that a signal passing through the phase shift unit 132-2 will not pass substantially through TS (e.g., because it may be configured as an open switch) while a signal passing through the phase shift unit 132-1 may pass at least partially through 502-1 (e.g., because it is configured to provide a capacitance for an LC core).

FIG. 6-2 illustrates, for the phase shifter 124 of FIG. 6-1, an overlay of example types of circuit topology for two of the three phase shift units. The first phase shift unit 132-1 includes a pi-type circuit 454 and another pi-type circuit 454′. The pi-type circuit 454 and the other pi-type circuit 454′ form two LC cores 402 for a differential implementation of the first phase shift unit 132-1. The second phase shift unit 132-2 includes a T-type circuit 452 and another T-type circuit 452′. The T-type circuit 452 and the other T-type circuit 452′ form two LC cores 402 for the second phase shift unit 132-2.

In example implementations, the first phase shift unit 132-1 therefore includes at least one LC core 402 (of FIG. 4). The LC core includes a first connector node N1 and a second connector node N2. The LC core also includes a transistor (e.g., a first transistor T1), a first inductor L1, and a second inductor L2. The first transistor T1 is coupled between the first connector node N1 and the second connector node N2. The first transistor T1 is configured to provide a capacitance 508 (e.g., of FIG. 5) to the LC core. The first inductor L1 is coupled to the first connector node N1 and is configured to provide a first inductance 506 (e.g., of FIG. 5) to the LC core. The second inductor L2 is coupled to the second connector node N2 and is configured to provide a second inductance 506 to the LC core.

As indicated by the dashed lines in FIG. 6-2, the LC core of the first phase shift unit 132-1 comprises a pi-type circuit 454. The first transistor T1, the first inductor L1, and the second inductor L2 are coupled together to form the pi-type circuit 454. The first transistor T1 is disposed at a top bar of the pi-type circuit 454, and the first inductor L1 and the second inductor L2 are disposed at respective vertical legs of the pi-type circuit 454. Further, the LC core can include a common node NC. The first inductor L1 is coupled between the first connector node N1 and the common node NC, and the second inductor L2 is coupled between the second connector node N2 and the common node NC.

In example implementations, the first phase shift unit 132-1 can further include a ground inductor LG, which is coupled to the common node NC, and a ground transistor TG, which is also coupled to the common node NC. In some implementations, the ground inductor LG and the ground transistor TG are coupled between the common node NC and a circuit ground. In other implementations, the first phase shift unit 132-1 is constructed as a differential circuit in which the ground inductor LG and the ground transistor TG realize a virtual ground for the differential signaling. In such cases, the first phase shift unit 132-1 can additionally include another first connector node N1′ and another second connector node N2′. The first phase shift unit 132-1 further includes another transistor (e.g., another first transistor T1′), another first inductor L1′, and another second inductor L2′. The other first transistor T1′ is coupled between the other first connector node N1′ and the other second connector node N2′ and is configured to provide another capacitance 508 to the other LC core (e.g., provided by the other T-type circuit 454′). The other first inductor L1′ is coupled between the other first connector node N1′ and another common node NC′ and is configured to provide another first inductance 506 to the other LC core. The other second inductor L2′ is coupled between the other second connector node N2′ and the other common node NC′ and is configured to provide another second inductance 506 to the other LC core. Here, the ground inductor LG is coupled between the common node NC and the other common node NC′. Similarly, the ground transistor TG is coupled between the common node NC and the other common node NC′.

In example implementations, the phase shifter 124 includes a second phase shift unit 132-2. The second phase shift unit 132-2 includes a third connector node N3, a fourth connector node N4, and another common node NOC. The second phase shift unit 132-2 also includes a third inductor L3, a fourth inductor L4, and a second transistor T2. The third inductor L3 is coupled between the third connector node N3 and the other common node NOC and is configured to provide a third inductance 506 to a second LC core of the second phase shift unit 132-2. The fourth inductor L4 is coupled between the fourth connector node N4 and the other common node NOC and is configured to provide a fourth inductance 506 to the second LC core. The second transistor T2 is coupled to the other common node NOC. The second transistor T2 is configured to provide a second capacitance 508 to the second LC core of the second phase shift unit 132-2.

As indicated by the dashed lines in FIG. 6-2, the second LC core of the second phase shift unit 132-2 comprises a T-type circuit 452. The second transistor T2, the third inductor L3, and the fourth inductor L4 are coupled together to form the T-type circuit 452. The third inductor L3 and the fourth inductor L4 are disposed along a top bar of the T-type circuit 452, and the second transistor T2 is disposed along a vertical post of the T-type circuit 452.

As used herein, terms such as “substantially” and “approximately” can refer to degrees of precision provided by real-world components versus ideal components. Thus, such terms can account for second and higher-order effects that result in deviations of up to 5-15%. Additionally or alternatively, terms such as “substantially” and “approximately” can refer to variances that are caused by process variations, as well as temperature and voltage changes due to operational conditions. Accordingly, such terms can accommodate variations corresponding to as much as 10-20%.

Also as used herein, one component can be coupled to another component electrically or electromagnetically from an operational perspective (e.g., may be operationally coupled) at a shared node or via one or more other components or nodes. Further, a component may be connected to another component directly or indirectly. If directly connected, two components share a common electrical node. If two components are indirectly connected, the two components are electrically connected via at least one intervening component that is disposed between the two components. As shown in FIG. 6-2, for example, the first inductor L1 is directly connected to a first terminal of the first transistor T1 at the first connector node N1, and the second inductor L2 is directly connected to a second terminal of the first transistor T1 at the second connector node N2. Similarly, the ground transistor TG is shown as being directly connected to the second inductor L2 and the other second inductor L2′. Although these components are explicitly shown as being directly connected one to another, the components may alternatively be indirectly connected with at least one other intervening component being coupled therebetween. As an example of two components that are indirectly connected, the first inductor L1 is indirectly connected to the other first inductor L1′ via the ground inductor LG (as well as via the ground transistor TG). Further, even if two components are directly connected from an architected perspective, there may be intervening parasitic effects (e.g., of a capacitive, inductive, or resistive nature) due to the ramifications of real-world structures and processes, and these intervening parasitic effects can be modeled using a virtual discrete or distributed intervening component. On a larger scale, the third phase shift unit 132-3 is depicted as being directly connected to the first phase shift unit 132-1 and indirectly connected to the second phase shift unit 132-2. However, the phase shift units may be interconnected in alternative orders.

FIG. 7 illustrates an example of circuitry for a phase shift unit 132-1 having an example pi-type circuit 454, which may be implemented for a 90° phase shift amount. Here, the LC core 402 (of FIG. 4) therefore corresponds to the pi-type circuit 454. The pi-type circuit 454 includes the first transistor 502-1 (T1), the first inductor 504-1 (L1), and the second inductor 504-2 (L2). Thus, the first transistor 502-1, the first inductor 504-1, and the second inductor 504-2 are coupled together to form a pi-type circuit topology. If the transistor 502-1 is turned off by the control signal Vc_90_bar (e.g., if the signal Vc_90_bar is low), the parasitic capacitance 510 of the transistor 502-1 is effective to participate in the LC core 402 by providing a capacitive effect. To achieve desired circuit parameters, the value of the capacitance C for this parasitic capacitance can be determined. The ground transistor TG (and the switch transistor TS of the second phase shift unit 132-2 of FIG. 6-2) may be designed to have a relatively low off-capacitance Coff. On the other hand, the transistors 502-1 (e.g., the first transistor T1 and the other first transistor T1′) may be designed to have a relatively high off-capacitance Coff to provide the capacitance 508 for the LC core 402 via the parasitic capacitance 510 thereof.

The pi-type circuit 454 illustrated in FIG. 7 can function as an LCL pi-type circuit responsive to the first transistor T1 being turned off by an activation signal for the first phase shift unit 132-1. An LCL pi-type circuit 454 can operate as a high-pass filter circuit. An equivalent circuit for the LCL pi-type circuit 454 is shown in the top right corner in the dashed-lines square. The LCL pi-type circuit 454 includes a capacitor C1, which represents the parasitic capacitance 510 of the first transistor T1 while turned off, coupled between the first connector node N1 and the second connector node N2. The first inductor L1 is coupled between the first connector node N1 and the ground 228, and the second inductor L2 is coupled between the second connector node N2 and the ground 228.

The pi-type circuit 454 is coupled to a ground network 706. The ground network 706 includes the ground inductor LG and the ground transistor TG. The ground network 706 can be shared with the other pi-type circuit 454′. As shown, the first inductor L1 has a first terminal that is connected to a first terminal of the first transistor T1 and has a second terminal that is connected (e.g., directly connected) to the ground network 706 via the common node NC. Similarly, the second inductor L2 has a first terminal that is connected to a second terminal of the first transistor T1 and has a second terminal that is connected (e.g., directly connected) to the ground network 706 via the common node NC. The ground 228 can be realized as a virtual ground 704 of a differential implementation of a phase shift unit 132 or a circuit ground of a single-ended implementation of the phase shift unit 132, which is depicted in FIG. 8. The circuit 702 includes the first transistor T1, the first inductor L1, and the second inductor L2. The circuit 702 also includes at least a portion of the ground inductor LG and the ground transistor TG. Thus, the circuit 702 can include the pi-type circuit 454 and at least a portion of the ground network 706. The ground inductor LG and the ground transistor TG provide the virtual ground 704 for the plus portion and the minus portion of the differential approach realized by the first phase shift unit 132-1.

For the corresponding LC core of a given phase shift unit 132, the inductance value of an inductive component and the capacitance value of a capacitive component can be determined based on a matching impedance (Zₒ), an operational frequency (ωₒ) (e.g., a center frequency of a relevant frequency range of interest of signals to be transmitted or received), or a desired phase shift amount 404 (ϕ). For example, appropriate inductance values and a capacitance value for the two inductive components (L1 and L2) and the capacitive component (C1), respectively, can be determined using Equations (1) and (2) as follows:

$$\begin{matrix}L = \frac{{Z}_{0}}{{ω}_{0} tan \vert ϕ \text{/} 2 \vert} , and & ( 1 ) \\ C = \frac{1}{{ω}_{0} {Z}_{0} sin \vert ϕ \vert} . & ( 2 )\end{matrix}$$

Given the above Equations (1) and (2), one of ordinary skill in the art can design or configure an appropriate inductor and transistor to provide a calculated inductance value and capacitance value, respectively. For example, a length, a width, or a shape of a signal path or conductive winding can be configured to provide an inductor a desired inductance value. Further, a length or a width of a channel, a type of transistor, an amount of doping, and so forth can be configured to provide a transistor with a desired capacitance value.

FIG. 8 illustrates an example portion of the first phase shift unit 132-1 (e.g., of FIG. 7) with regard to two operational modes that can be utilized with the pi-type circuit 454, e.g., to generate a 90° phase shift amount. More specifically, a single-ended version of the circuit 702 is shown in FIG. 8. The first transistor T1 (e.g., the first transistor 502-1) extends between the first connection node N1 (corresponding to a drain node D) and a second connection node N2 (corresponding to a source node S). A gate terminal G of the transistor T1 is coupled to the control signal Vc via a control resistor Rc. The first inductor L1 (e.g., the first inductor 504-1) and the second inductor L2 (e.g., the second inductor 504-2) are coupled respectively between the drain node D and the source node S and a common node CN (e.g., a common node 802). The ground inductor LG and the ground transistor TG are coupled between the common node CN and an equipotential node, such as a circuit ground 812. Another bias resistor is coupled between a gate terminal of the ground transistor TG and the control signal Vc bar. An example activation circuit 814 is also indicated. The activation circuit 814 can facilitate changing between two or more modes—two of which are shown in FIG. 8 on the right.

The first and second inductors L1 and L2 can have the same or different inductance values with respect to each other (and to the ground inductor LG). The size and proportions of the first transistor T1 can be set to establish a capacitance value that is determined using Equation (2) above based on a targeted phase shift amount. In this example, as indicated by the illustrated symbol for the first transistor T1, neither the source terminal S nor the drain terminal D of the first transistor T1 is coupled to, e.g. tied to, a body or bulk of the first transistor T1. In other examples, the body of the transistor T1 (or another transistor) can be coupled to a channel terminal (e.g., a source terminal S or a drain terminal D). Although operational modes are described for FIG. 8 with reference to a single-ended implementation of a phase shift unit 132, the principles of the operational modes are applicable to a differential implementation of a phase shift unit 132.

Two example modes are shown in FIG. 8. A bypass mode 804 corresponds to the phase shift unit 132 being deactivated, and a phase delay mode 806 corresponds to the phase shift unit 132 being activated. If the first transistor T1 is turned on by the control signal Vc (as represented by an arrow 808), the bypass mode 804 for the corresponding phase shift unit 132 is activated. In the bypass mode 804, the first transistor T1 functions like a resistor having an on-resistance Ron_1. Further, the ground transistor TG is turned off, which provides an off-ground-capacitance Coff_G between the common node CN and the circuit ground 812. Thus, a signal that is traversing through a phase shifter 124 (e.g., of FIG. 6-2) propagates through the on-resistance Ron_1 of the first transistor T1 and is not substantially phase shifted as the signal transits the circuit 702 that is operating in the bypass mode 804.

On the other hand, if the first transistor T1 is turned off by the control signal Vc (as represented by an arrow 810), a phase delay mode 806 is enabled to activate the corresponding phase shift unit 132. In the phase delay mode 806, the first transistor T1 functions like a capacitor having an off-capacitance Coff_1. This off-capacitance Coff_1 is sufficient to contribute a capacitance to the LC core of the phase shift unit 132. Further, the ground transistor TG is turned on, which provides an on-ground-resistance Ron_G between the common node CN and the circuit ground 812. Thus, a signal that is traversing through a phase shifter 124 propagates through the first transistor T1, the first inductor L1, and the second inductor L2 jointly as the LC core of the corresponding phase shift unit 132. Based on the inductance and capacitance values of the LC core, the propagating signal is phase shifted by a designed number of degrees (e.g., 90° in this example) as the signal transits the circuit 702 while operating in the phase delay mode 806.

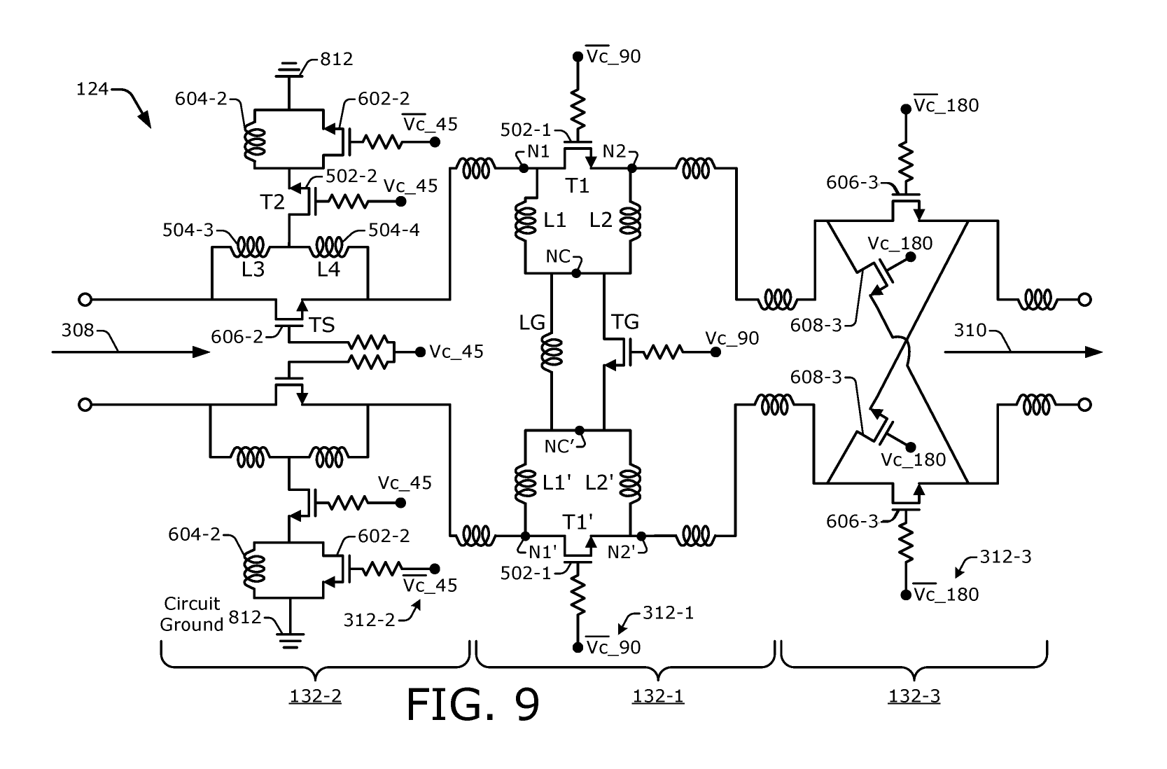

FIG. 9 illustrates alternative example circuitry for a phase shifter 124 having three phase shift units 132, each of which corresponds to a different example phase shift amount. FIG. 7 illustrates a differential signaling approach that utilizes a virtual ground 704 for both the first and second phase shift units 132-1 and 132-2. In contrast, FIG. 8 illustrates a single-ended signaling approach that utilizes a circuit ground 812. FIG. 9, however, illustrates two approaches: A differential approach utilizes a virtual ground as shown in FIG. 7 for the first phase shift unit 132-1, but another differential approach utilizes a circuit ground 812 for the second phase shift unit 132-2.

The second phase shift unit 132-2 of FIG. 9 is similar to the second phase shift unit 132-2 of FIGS. 6-1 and 6-2 in that both utilize differential signaling. In FIG. 6-1, the second phase shift unit 132-2 shares the inductor 604-2 and the transistor 602-2 (e.g., utilizes one ground network) between the plus and minus portions of a differential signal or circuit to establish a virtual ground. In contrast, the second phase shift unit 132-2 of FIG. 9 implements differential signaling using the circuit ground 812. To do so, this second phase shift unit 132-2 duplicates the inductor 604-2 and the transistor 602-2 for each of the plus and minus signaling portions (e.g., utilizes two ground networks) (as indicated at the top and bottom of the depicted circuit).

Thus, a circuit ground 812 can be employed for differential signaling at the cost of duplicating one inductor and one transistor at each phase shift unit 132. Although not explicitly shown, the pi-circuit of the first phase shift unit 132-1 may also be employed with the circuit ground 812 by duplicating the ground inductor LG and the ground transistor TG. Further, although not explicitly shown, a switch transistor 606-2 (TS) may include a bulk (B) terminal that is coupled to ground via a resistor or a deep n-well (DNW) terminal that is coupled to a supply voltage via a resistor.

In one or more of the embodiments described above, the inductors can be implemented using conductive coils or solenoid-type inductors, for example. In some of such embodiments, these implementations occupy less area on an integrated circuit chip than other inductor implementations. In some implementations, one or more of the embodiments described herein are implemented in a 28 GHz dual polarization CMOS transceiver and/or are implemented in a 28LP-RF process that may be packaged for either a handset (e.g., a user equipment (UE)) or a base station (e.g., a gNB) application. In other implementations, one or more of the embodiments described herein are implemented in a transceiver having a different operating frequency, such as below 20 GHz or above 30 GHz.

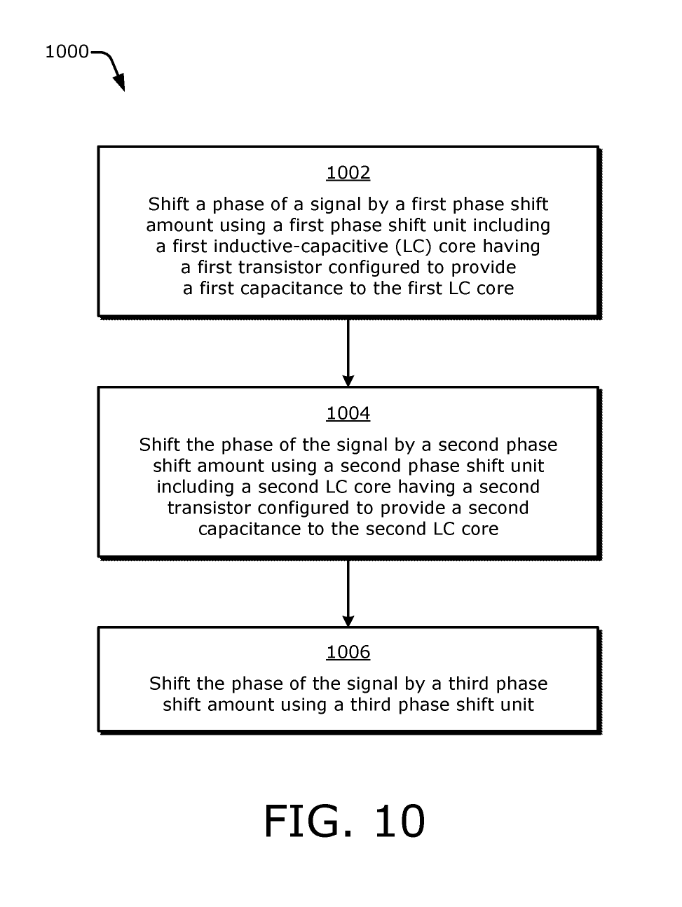

FIG. 10 is a flow diagram illustrating an example process 1000 for operating a phase shifter with multiple switched phase shift units. The process 1000 is described in the form of a set of blocks 1002-1006 that specify operations that can be performed. However, operations are not necessarily limited to the order shown in FIG. 10 or described herein, for the operations may be implemented in alternative orders or in fully or partially overlapping manners. Also, fewer, more, and/or different operations may be implemented to perform the process 1000, or an alternative process. Operations represented by the illustrated blocks of the process 1000 may be performed by a phase shifter 124. More specifically, the operations of the process 1000 may be performed by multiple phase shift units 132 of a phase shifter 124 that is controlled by a phase shifter controller 304.

At block 1002, a phase of a signal is shifted by a first phase shift amount using a first phase shift unit including a first inductive-capacitive (LC) core having a first transistor configured to provide a first capacitance to the first LC core. For example, a first phase shift unit 132-1 can shift a phase of a signal by a first phase shift amount 404-1 using a first inductive-capacitive core 402-1 (first LC core 402-1). The first LC core 402-1 can include a first transistor 502-1 (T1) that is configured to contribute a parasitic capacitance 510 thereof to provide a first capacitance 508 to the first LC core 402-1. The first LC core 402-1 may be realized using, for instance, a pi-type circuit topology (e.g., a pi-type circuit 454 that includes the first transistor T1).

At block 1004, the phase of the signal is shifted by a second phase shift amount using a second phase shift unit including a second LC core having a second transistor configured to provide a second capacitance to the second LC core. For example, a second phase shift unit 132-2 can shift the phase of the signal by a second phase shift amount 404-2 using a second LC core 402-2 including a second transistor 502-2 (T2) that is configured to contribute a parasitic capacitance 510 to provide a capacitance 508 to the second LC core 402-2. The second LC core 402-2 may be realized using, for instance, a T-type circuit topology (e.g., a T-type circuit 452 that includes the second transistor T2). Thus, in some embodiments, the topology of the first LC core 402-1 (e.g., a pi-type circuit 454) may be different than the topology of the second LC core 402-2 (e.g., a T-type circuit 452).

At block 1006, the phase of the signal is shifted by a third phase shift amount using a third phase shift unit. For example, a third phase shift unit 132-3 can shift the phase of the signal by a third phase shift amount 404-3. The third phase shift unit 132-3 may include a pair of cross-coupled transistors 608-3 to invert a phase of a differential signal by one-hundred-and-eighty degrees (180°). Alternatively, a third LC core 402-3 can be used by the third phase shift unit 132-3, including but not limited to single-ended implementations of the third phase shift unit 132-3.

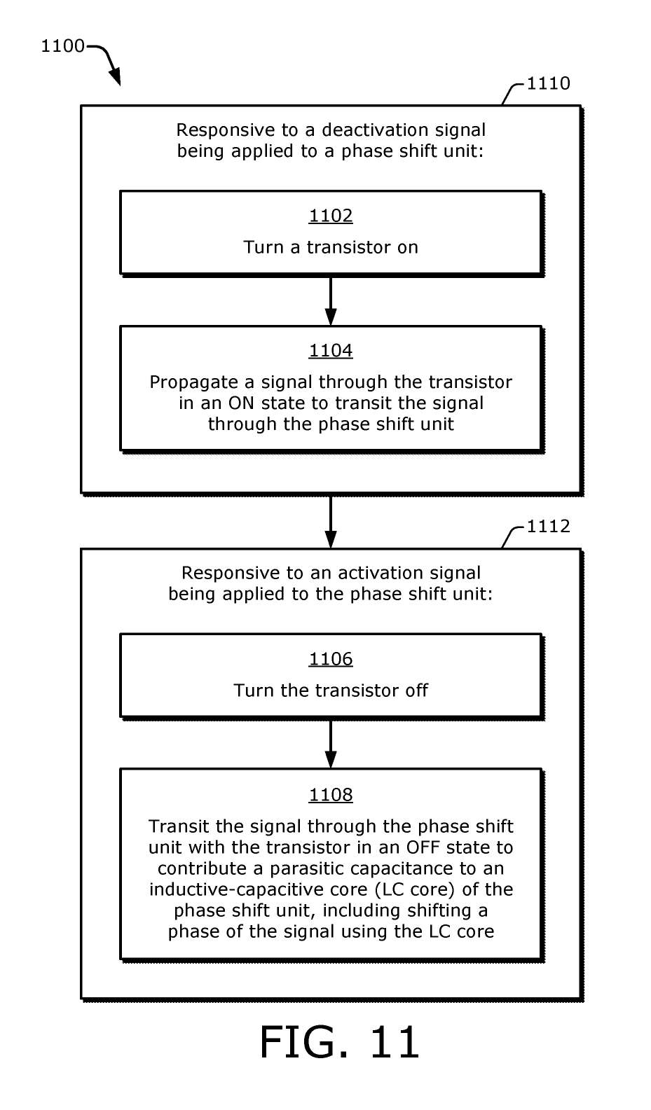

FIG. 11 is a flow diagram 1100 illustrating an example process for operating at least one phase shift unit, which can include a pi-type circuit. The process 1100 is described in the form of a set of blocks 1102-1112 that specify operations that can be performed. However, operations are not necessarily limited to the order shown in FIG. 11 or described herein, for the operations may be implemented in alternative orders or in fully or partially overlapping manners. Also, fewer, more, and/or different operations may be implemented to perform the process 1100, or an alternative process. Further, one or more operations of the blocks 1102-1108 may be conditioned differently as compared to the indications at 1110 and 1112. Generally, operations represented by the illustrated blocks of the process 1100 may be performed by a phase shift unit 132. More specifically, the operations of the process 1100 may be performed by a phase shift unit 132 that includes a pi-type circuit 454 and that is responsive to control signals received from a phase shifter controller 304.

The operations of blocks 1102 and 1104 are performed responsive to a deactivation signal being applied to a phase shift unit (as indicated at block 1110). For example, a first phase shift unit 132-1 can operate in response to receiving a first shift-unit control signal 312-1 that has a value indicative of deactivating the first phase shift unit 132-1. At block 1102, a transistor is turned on. For example, a phase shifter controller 304 can turn on a first transistor 502-1 (T1). To do so, a voltage can be applied to a gate terminal of the first transistor 502-1 (T1) to cause the transistor to enter an ON state.

At block 1104, a signal is propagated through the transistor in an ON state to transit the signal through the phase shift unit. For example, the first phase shift unit 132-1 can permit a signal (e.g., a communication signal 308, an intermediate signal 406, or an incoming signal 512) to propagate through the first transistor 502-1 (T1) while in the ON state. Thus, in the deactivation mode, the signal transits through the first phase shift unit 132-2. During such operation, the signal may propagate primarily through the first transistor 502-1 (T1), as opposed to alternatively or additionally propagating through other portions of the first phase shift unit 132-1. This permission may be performed by entering a bypass mode 804 in which the first transistor 502-1 (T1) functions to provide a resistance to a propagating signal. The first transistor 502-1 (T1) may be disposed along a top bar of a pi-type circuit 454 that extends between a first connection node (N1) and a second connection node (N2). The pi-type circuit 454 can be part of an LC core 402 that is tuned to shift a phase of a signal with a given operational frequency by a desired number of degrees, such as 90°.

The operations of blocks 1106 and 1108 are performed responsive to an activation signal being applied to the phase shift unit (as indicated at block 1112). For example, the first phase shift unit 132-1 can operate in response to receiving a first shift-unit control signal 312-1 that has a value indicative of activating the first phase shift unit 132-1. At block 1106, the transistor is turned off. For example, the phase shifter controller 304 can turn off the first transistor 502-1 (T1). To do so, a voltage can be applied to the gate terminal of the first transistor 502-1 (T1) to cause the transistor to enter an OFF state. Here, the first transistor 502-1 (T1) is configured to exhibit a parasitic capacitance 510 at the operating frequency while turned off.

At block 1108, the signal transits through the phase shift unit with the transistor in an OFF state to contribute a parasitic capacitance to an LC core of the phase shift unit. By transiting through the phase shift unit, a phase of the signal is shifted using the LC core. For example, the signal to be phase shifted can transit through the first phase shift unit 132-1 with the first transistor 502-1 (T1) in the OFF state to contribute the parasitic capacitance 510 thereof to the LC core 402 of the first phase shift unit 132-1. By transiting the signal through the LC core 402, the phase of the signal is shifted based on one or more inductance values and at least one capacitance value of components included in the LC core 402. For example, a portion of the signal may be propagated through the first transistor 502-1 (T1), while other portions of the signal may be shunted to ground using one or more inductors of the LC core 402. The LC core 402 may be formed from the pi-type circuit 454 including a top bar having the first transistor 502-1 (T1) and including vertical legs respectively having a first inductor 504-1 (L1) and a second inductor 504-2 (L2).

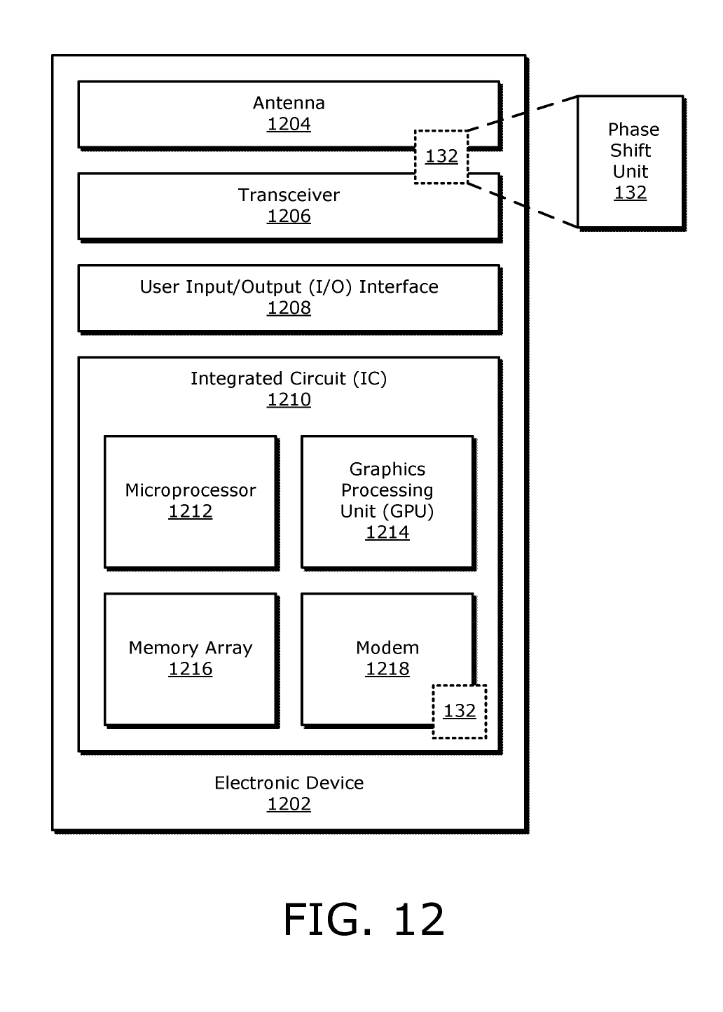

FIG. 12 illustrates an example electronic device 1202 in which a phase shift unit 132 can be implemented. As shown, the electronic device 1202 includes an antenna 1204, a transceiver 1206, a user input/output (I/O) interface 1208, and an integrated circuit 1210 having at least one core. Illustrated examples of the integrated circuit 1210, or cores thereof, include a microprocessor 1212, a graphics processing unit (GPU) 1214, a memory array 1216, and a modem 1218. In one or more example implementations, a phase shifter 124 (e.g., of FIGS. 1 and 2) with at least one phase shift unit 132 as described herein can be implemented by the transceiver 1206, by the modem 1218 of the integrated circuit 1210, as part of an RF front-end that includes the antenna 1204, and so forth. The phase shift unit 132 can be implemented such that a signal having a desired phase shift can be generated using at least one transistor 502 configured to selectively function as a capacitor as part of an LC core 402 (e.g., of FIG. 5).

The electronic device 1202 can be a mobile or battery-powered device or a fixed device that is designed to be powered by an electrical grid. Examples of the electronic device 1202 include a base station, an access point (AP), a server computer, a network switch or router, a blade of a data center, a personal computer, a desktop computer, a notebook or laptop computer, a tablet computer, a smart phone, an entertainment appliance, or a wearable computing device such as a smartwatch, intelligent glasses, or an article of clothing. An electronic device 1202 can also be a device, or a portion thereof, having embedded electronics. Examples of the electronic device 1202 with embedded electronics include a passenger vehicle, industrial equipment, a refrigerator or other home appliance, a drone or other unmanned aerial vehicle (UAV), or a power tool.

For an electronic device with a wireless capability, the electronic device 1202 includes an antenna 1204 that is coupled to a transceiver 1206 to enable reception or transmission of one or more wireless signals. The integrated circuit 1210 may be coupled to the transceiver 1206 to enable the integrated circuit 1210 to have access to received wireless signals or to provide wireless signals for transmission via the antenna 1204. The electronic device 1202 as shown also includes at least one user I/O interface 1208. Examples of the user I/O interface 1208 include a keyboard, a mouse, a microphone, a touch-sensitive screen, a camera, an accelerometer, a haptic mechanism, a speaker, a display screen, or a projector.

The integrated circuit 1210 may comprise, for example, one or more instances of a microprocessor 1212, a GPU 1214, a memory array 1216, a modem 1218, and so forth. The microprocessor 1212 may function as a central processing unit (CPU) or other general-purpose processor. Some microprocessors include different parts, such as multiple processing cores, that may be individually powered on or off. The GPU 1214 may be especially adapted to process visual-related data for display, such as video data images. If visual-related data is not being rendered or otherwise processed, the GPU 1214 may be fully or partially powered down. The memory array 1216 stores data for the microprocessor 1212 or the GPU 1214. Example types of memory for the memory array 1216 include random access memory (RAM), such as dynamic RAM (DRAM) or static RAM (SRAM); flash memory; and so forth. If programs are not accessing data stored in memory, the memory array 1216 may be powered down overall or block-by-block. The modem 1218 demodulates a signal to extract encoded information or modulates a signal to encode information into the signal. If there is no information to decode from an inbound communication or to encode for an outbound communication, the modem 1218 may be idled to reduce power consumption. The integrated circuit 1210 may include additional or alternative parts than those that are shown, such as an I/O interface, a sensor such as an accelerometer, a transceiver or another part of a receiver chain, a customized or hard-coded processor such as an application-specific integrated circuit (ASIC), and so forth.

The integrated circuit 1210 may also comprise a system on a chip (SOC). An SOC may integrate a sufficient number of different types of components to enable the SOC to provide computational functionality as a notebook computer, a mobile phone, or another electronic apparatus using one chip, at least primarily. Components of an SOC, or an integrated circuit 1210 generally, may be termed cores or circuit blocks. Examples of cores or circuit blocks include, in addition to those that are illustrated in FIG. 12, a voltage regulator, a main memory or cache memory block, a memory controller, a general-purpose processor, a cryptographic processor, a video or image processor, a vector processor, a radio, an interface or communications subsystem, a wireless controller, or a display controller. Any of these cores or circuit blocks, such as a central processing unit or a multimedia processor, may further include multiple internal cores or circuit blocks.

The various descriptions for a phase shift unit provided above can be modified, combined, extended, rearranged, and so forth to realize one or more phase shift unit implementations. In example aspects, an apparatus has a phase shifter including a first phase shift unit, a second phase shift unit, and a third phase shift unit. The first phase shift unit corresponds to a first phase shift amount, and the first phase shift unit includes a first inductive-capacitive core (LC core) having a pi-type circuit topology. The second phase shift unit is coupled to the first phase shift unit. The second phase shift unit corresponds to a second phase shift amount, and the second phase shift unit includes a second LC core having a T-type circuit topology. The third phase shift unit is coupled to the first phase shift unit, and the third phase shift unit corresponds to a third phase shift amount.

In some implementations, the first LC core includes a first transistor, a first inductor, and a second inductor. The first transistor is disposed along a top bar of the pi-type circuit topology, and the first and second inductors are disposed along respective vertical legs of the pi-type circuit topology. Further, the second LC core includes a second transistor, a third inductor, and a fourth inductor. The second transistor is disposed along a vertical post of the T-type circuit topology, and the third and fourth inductors are disposed along a top bar of the T-type circuit topology.

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Further, items represented in the accompanying figures and terms discussed herein may be indicative of one or more items or terms, and thus reference may be made interchangeably to single or plural forms of the items and terms in this written description. Finally, although subject matter has been described in language specific to structural features or methodological operations, it is to be understood that the subject matter defined in the appended claims is not necessarily limited to the specific features or operations described above, including not necessarily being limited to the organizations in which features are arranged or the orders in which operations are performed.

What is claimed is:

1. An apparatus comprising:
a phase shift unit including an inductive-capacitive core (LC core), the LC core comprising:
a first connector node;
a second connector node;
a transistor having a first terminal coupled to the first connector node and a second terminal coupled to the second connector node, the transistor configured to selectively provide a capacitance to the LC core;
a first inductor coupled to the first connector node, the first inductor configured to provide a first inductance to the LC core; and
a second inductor coupled to the second connector node, the second inductor configured to provide a second inductance to the LC core.

2. The apparatus of claim 1, wherein:
the transistor is configured to selectively provide the capacitance to the LC core using a parasitic capacitance of the transistor while the transistor is switched off.

3. The apparatus of claim 2, wherein:
the transistor is configured to selectively provide a resistance between the first connector node and the second connector node while the transistor is switched on.

4. The apparatus of claim 3, further comprising:
a phase shifter controller coupled to the transistor, the phase shifter controller configured to:
turn the transistor on to deactivate the phase shift unit and cause the phase shift unit to pass a signal without substantially shifting a phase of the signal; and
turn the transistor off to activate the phase shift unit to cause the phase shift unit to shift the phase of the signal.

5. The apparatus of claim 1, wherein:
the LC core comprises a pi-type circuit;
the transistor, the first inductor, and the second inductor are coupled together to form the pi-type circuit; and
the transistor is disposed at a top bar of the pi-type circuit, and the first inductor and the second inductor are disposed at respective vertical legs of the pi-type circuit.

6. The apparatus of claim 1, wherein:
the first terminal or the second terminal comprises a source terminal of the transistor, the transistor further comprising a body; and
the source terminal is uncoupled from the body.

7. The apparatus of claim 1, wherein:
the phase shift unit is configured to selectively shift a phase of a signal by approximately ninety degrees (90°).

8. The apparatus of claim 1, wherein:
the first terminal comprises a source terminal and the second terminal comprises a drain terminal;
the transistor is coupled between the first connector node and the second connector node via the source terminal and the drain terminal;
the LC core comprises a common node;
the first inductor is coupled between the first connector node and the common node; and
the second inductor is coupled between the second connector node and the common node.

9. The apparatus of claim 8, wherein the phase shift unit includes:
a ground inductor coupled to the common node; and
a ground transistor coupled to the common node.

10. The apparatus of claim 9, wherein:
the ground inductor is coupled between the common node and a circuit ground; and
the ground transistor is coupled between the common node and the circuit ground.

11. The apparatus of claim 9, wherein the phase shift unit includes another LC core, the other LC core comprising:
another first connector node;
another second connector node;
another transistor having a first terminal coupled to the other first connector node and a second terminal coupled to the other second connector node, the other transistor configured to selectively provide another capacitance to the other LC core;
another first inductor coupled between the other first connector node and another common node, the other first inductor configured to provide another first inductance to the other LC core; and
another second inductor coupled between the other second connector node and the other common node, the other second inductor configured to provide another second inductance to the other LC core, wherein
the ground inductor is coupled between the common node and the other common node; and
the ground transistor is coupled between the common node and the other common node.

12. The apparatus of claim 1, further comprising:
a phase shifter, wherein:
the phase shift unit comprises a first phase shift unit;
the LC core comprises a first LC core;
the phase shifter includes the first phase shift unit and a second phase shift unit; and
the second phase shift unit includes a second LC core.

13. The apparatus of claim 12, wherein the second LC core comprises:
a third connector node;
a fourth connector node;
a common node;
a third inductor coupled between the third connector node and the common node, the third inductor configured to provide a third inductance to the second LC core;
a fourth inductor coupled between the fourth connector node and the common node, the fourth inductor configured to provide a fourth inductance to the second LC core; and
a second transistor coupled to the common node, the second transistor configured to selectively provide a second capacitance to the second LC core.

14. The apparatus of claim 13, wherein:
the second LC core comprises a T-type circuit;
the second transistor, the third inductor, and the fourth inductor are coupled together to form the T-type circuit; and
the third inductor and the fourth inductor are disposed along a top bar of the T-type circuit, and the second transistor is disposed along a vertical post of the T-type circuit.

15. The apparatus of claim 13, wherein the second phase shift unit includes:
a switch transistor coupled between the third connector node and the fourth connector node, wherein:
the switch transistor is configured to function substantially like an open switch while the switch transistor is turned off; and
the switch transistor is configured to function substantially like a closed switch to short the third connector node and the fourth connector node together while the switch transistor is turned on.

16. The apparatus of claim 15, further comprising:
a phase shifter controller coupled to the switch transistor, the phase shifter controller configured to:
turn the switch transistor on to deactivate the second phase shift unit and cause the second phase shift unit to pass a signal without substantially shifting a phase of the signal; and
turn the switch transistor off to activate the second phase shift unit to cause the second phase shift unit to shift the phase of the signal.

17. The apparatus of claim 13, wherein:
the first phase shift unit is configured to shift a phase of a signal by a first phase shift amount;
the second phase shift unit is configured to shift the phase of the signal by a second phase shift amount; and
the phase shifter includes a third phase shift unit, the third phase shift unit configured to shift the phase of the signal by a third phase shift amount.

18. The apparatus of claim 17, wherein:
the first phase shift amount comprises approximately ninety degrees (˜90°);
the second phase shift amount comprises approximately forty-five degrees (˜45°);
the third phase shift amount comprises approximately one hundred-and-eighty degrees (˜180°); and
the first phase shift unit is coupled between the second phase shift unit and the third phase shift unit.

19. The apparatus of claim 17, wherein:
the phase shifter comprises a differential phase shifter; and
the third phase shift unit comprises a pair of transistors that are cross-coupled across the third phase shift unit.

20. The apparatus of claim 1, further comprising:
a phase shifter including the phase shift unit;
a power amplifier coupled to the phase shifter;
a low-noise amplifier coupled to the phase shifter; and
an antenna coupled to the power amplifier and the low-noise amplifier.

21. The apparatus of claim 20, further comprising:
a display screen; and
at least one processor operatively coupled to the display screen and the phase shifter, the at least one processor configured to cause the display screen to display information received via the antenna, the low-noise amplifier, and the phase shifter.

22. The apparatus of claim 1, wherein:
the first connector node is coupled to an input of the phase shift unit; and
the second connector node is coupled to an output of the phase shift unit.

23. A system comprising:
a phase shifter including:
a first phase shift unit corresponding to a first phase shift amount, the first phase shift unit including means for shifting a phase of a signal with a pi-type circuit topology using a transistor that is configured to selectively contribute a parasitic capacitance to an inductive-capacitive core (LC core) of the first phase shift unit;
a second phase shift unit coupled to the first phase shift unit, the second phase shift unit corresponding to a second phase shift amount; and
a third phase shift unit coupled to the first phase shift unit, the third phase shift unit corresponding to a third phase shift amount.

24. The system of claim 23, wherein:
the second phase shift unit includes means for shifting the phase of the signal with a T-type circuit topology.

25. A method for operating at least one phase shift unit, the method comprising:
responsive to a deactivation signal being applied to a phase shift unit, turning a transistor on; and
propagating a signal through the transistor in an ON state to transit the signal through the phase shift unit; and
responsive to an activation signal being applied to the phase shift unit, turning the transistor off; and
transiting the signal through the phase shift unit with the transistor in an OFF state to contribute a parasitic capacitance to an inductive-capacitive core (LC core) of the phase shift unit, including shifting a phase of the signal using the LC core.

26. The method of claim 25, wherein the transiting of the signal comprises:
propagating the signal through a pi-type circuit in which a top bar of the pi-type circuit includes the transistor and each vertical leg of the pi-type circuit includes a respective inductor.

27. The method of claim 25, further comprising:
responsive to another deactivation signal being applied to another phase shift unit,
turning a switch transistor on; and
propagating the signal through the switch transistor in the ON state to transit the signal through the other phase shift unit; and
responsive to another activation signal being applied to the other phase shift unit,
turning the switch transistor off;
turning another transistor off to cause the other transistor to contribute another parasitic capacitance to another LC core of the other phase shift unit; and
transiting the signal through the other phase shift unit with the other transistor in an OFF state, including shifting the phase of the signal using the other LC core, the other LC core comprising a T-type circuit having a vertical post including the other transistor.

28. A phase shift unit, comprising:
a transistor having a first terminal connected to an input of the phase shift unit and a second terminal connected to an output of the phase shift unit;
a first inductor having a first terminal connected to the first terminal of the transistor and having a second terminal directly connected to a ground network; and
a second inductor having a first terminal connected to the second terminal of the transistor and having a second terminal directly connected to the ground network.

29. The phase shift unit of claim 28, wherein:
the phase shift unit comprises a differential phase shift unit having a plus portion and a minus portion;
the plus portion includes the transistor, the first inductor, and the second inductor;
the ground network comprises a ground inductor and a ground transistor; and
the ground network is coupled between the plus portion and the minus portion of the differential phase shift unit.

30. The phase shift unit of claim 28, wherein:
the ground network comprises a ground inductor and a ground transistor that are directly connected to the first inductor and the second inductor and that are coupled between the first and second inductors and a circuit ground.
